(19) United States
(12) Patent Application Publication
(10) Pub. No.: US 2026/0008178 A1
(43) Pub. Date: Jan. 8, 2026

(54) HUMANOID ROBOT HAVING ADVANCED JOINT ASSEMBLIES

(71) Applicant: FIGURE AI INC., San Jose, CA (US)

(72) Inventors: David McCall, San Jose, CA (US); Sydney Hardy, San Jose, CA (US); Robert Gruendel, San Jose, CA (US)

(21) Appl. No.: 19/180,106

(22) Filed: Apr. 15, 2025

Related U.S. Application Data
(60) Provisional application No. 63/633,931, filed on Apr. 15, 2024.

(51) Int. Cl. B25J 9/16; B25J 5/00; B25J 9/10; B25J 19/00; B62D 57/032

(52) U.S. Cl. CPC B25J 9/1633; B25J 5/00; B25J 9/1025; B25J 19/0091; B62D 57/032

(57) ABSTRACT

The present disclosure provides a humanoid robot comprising an actuator with a rotational axis and a momentary peak torque rating greater than 70 N-m. The robot includes a first assembly and a second assembly coupled to the actuator, each lacking a recess for receiving an extent of the actuator in a fully flexed position. The first assembly has a first interior point and a first exterior point, while the second assembly has a second interior point and a second exterior point. The rotational axis is substantially centered between both the first interior and exterior points and the second interior and exterior points. This configuration allows for efficient joint movement while maintaining structural integrity and minimizing potential pinch points.

### CROSS REFERENCE TO RELATED APPLICATIONS

This application claims the benefit of and priority to U.S. Provisional Patent Application No. 63/633,931 filed on Apr. 15, 2024, which is expressly incorporated by reference herein in its entirety.

Reference is hereby made to: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, (ii) U.S. patent application Ser. Nos. 18/919,263, 18/919,274, 19/000,626, 19/006,191, 19/038,657, 19/064,596, 19/066,122, and (iii) U.S. Provisional Patent Application Nos. 63/557,874, 63/558,373, 63/561,300, 63/561,307, 63/561,311, 63/561,313, 63/561,315, 63/564,741, 63/565,077, 63/573,226, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,040, 63/626,105, 63/632,630, 63/632,683, 63/633,113, 63/633,405, 63/633,920, 63/634,599, 63/634,697, 63/685,856, 63/696,507, 63/696,533, 63/700,749, 63/706,768, 63/707,547, 63/708,003, 63/722,057, 63/633,941, 63/635,152, 63/556,102, 63/561,317, 63/561,318, 63/626,039, and 63/766,911, each of which is expressly incorporated by reference herein in its entirety.

### TECHNICAL FIELD

This disclosure relates to a humanoid robot having advanced joint assemblies, wherein said humanoid robot includes a rotation limiting system that comprises assemblies (e.g., a protective assembly and a dissipation assembly) that are positioned near, adjacent to, or within a joint of said humanoid robot.

### BACKGROUND

The contemporary industrial and service landscape faces significant challenges, including labor shortages, particularly for tasks considered undesirable or hazardous. This situation drives a growing demand for advanced automation and robotic systems capable of enhancing productivity and supplementing the human workforce. Consequently, there is increasing development and integration of advanced robots designed to operate effectively in environments structured for humans.

A prominent approach involves the use of general-purpose humanoid robots. These robots are engineered to emulate human form and functionality, typically featuring bipedal locomotion, articulated arms, and sensory interfaces, allowing them to perform a wide range of tasks traditionally carried out by human workers. The humanoid design aims to facilitate seamless integration into existing human-centric workspaces without requiring extensive environmental modifications.

However, replicating the complexity and adaptability of human movement presents considerable engineering challenges, especially concerning the design of robotic joints. For humanoid robots to operate effectively and safely, their joints must closely mimic the range of motion, flexibility, and inherent safety mechanisms found in human counterparts. This includes the ability to absorb energy during dynamic movements and protect against damage from impacts, collisions, or hyperextension. Traditional robotic joint designs often face limitations in balancing the need for precise motion control with the requirements for robustness, safety, and energy management, particularly within the constraints of a human-like form factor. There is an ongoing need for innovation in robotic joint technology, focusing on advanced materials, energy absorption and dissipation systems, and integrated protective elements.

### SUMMARY OF INVENTION

The present disclosure provides a humanoid robot comprising: an actuator having a rotational axis and a momentary peak torque that is greater than 75 N-m; a first assembly coupled to the actuator and including a first interior point and a first exterior point, wherein the first assembly lacks a recess configured to receive an extent of the actuator in a fully flexed position; a second assembly coupled to the actuator and including a second interior point and a second exterior point, wherein the second assembly lacks a recess configured to receive an extent of the actuator in a fully flexed position; and wherein the rotational axis is substantially centered between both: (i) the first interior and exterior points, and (ii) the second interior and exterior points.

The present disclosure provides a humanoid robot comprising: an actuator having an actuator axis and a momentary peak torque that is between 75 and 500 N-m; a first housing coupled to the actuator; a second housing coupled to the actuator; wherein if a pressure greater than 250 N/cm² is applied to an object by an extent of the first housing and the second housing when the second housing is moving towards the first housing about the actuator axis, then the humanoid robot will stop said movement of the second housing towards the first housing.

The present disclosure provides a humanoid robot comprising: a joint formed between a first housing and a second housing; an energy attenuation member coupled to one of the first housing or the second housing; and wherein when the joint is in a fully flexed position, a force that is less than 140 N is applied to an object that is positioned between an extent of the energy attenuation member and an extent of one of the first or second housings.

The present disclosure provides a humanoid robot, comprising: an upper region including a torso and at least one arm; a lower region including at least one leg; a central region connecting the upper region and the lower region; and a rotation limiting system positioned near a joint of the humanoid robot, the rotation limiting system comprising: a protective assembly having at least one deformable member positioned on an external portion of the joint to limit hyperextension; and a dissipation assembly having at least one energy attenuation member positioned on an internal portion of the joint, wherein the protective assembly limits hyperextension of the joint and the dissipation assembly absorbs energy during flexion.

The present disclosure provides a method of operating a humanoid robot, comprising: actuating an elbow joint of the humanoid robot; limiting hyperextension of the elbow joint using a protective assembly having an upper deformable member coupled to a lower humerus and a lower deformable member coupled to an upper forearm; and absorbing energy during flexion of the elbow joint using a dissipation assembly having an elbow energy attenuation member coupled to a front portion of the lower humerus.

The present disclosure provides an arm assembly for a humanoid robot, comprising: a lower humerus; an upper forearm; an elbow joint connecting the lower humerus and the upper forearm; and a rotation limiting system positioned at the elbow joint, the rotation limiting system comprising: a protective assembly having an upper deformable member coupled to a rear portion of the lower humerus and a lower deformable member coupled to a rear portion of the upper forearm; and a dissipation assembly having an elbow energy attenuation member coupled to a front portion of the lower humerus.

The present disclosure provides a leg assembly for a humanoid robot, comprising: a lower thigh; a shin; a knee joint connecting the lower thigh and the shin; and a rotation limiting system positioned at the knee joint, the rotation limiting system comprising: a protective assembly having an upper deformable member coupled to a front portion of the lower thigh and a lower deformable member coupled to a front portion of the shin; and a dissipation assembly having an upper knee energy attenuation member coupled to a rear portion of the lower thigh and a lower knee energy attenuation member coupled to a rear portion of the shin.

The present disclosure provides a method of manufacturing a rotation limiting system for an elbow joint of a humanoid robot, comprising: forming an upper deformable member configured to be coupled to a rear portion of a lower humerus; forming a lower deformable member configured to be coupled to a rear portion of an upper forearm; forming an elbow energy attenuation member configured to be coupled to a front portion of the lower humerus; and positioning the upper deformable member, the lower deformable member, and the elbow energy attenuation member at the elbow joint such that the upper and lower deformable members contact each other during hyperextension of the elbow joint and the elbow energy attenuation member compresses during flexion of the elbow joint.

The present disclosure provides a method of controlling a humanoid robot, comprising: detecting movement at a joint of the humanoid robot; determining if the movement exceeds a predetermined threshold; and preventing movement at the joint if the movement exceeds the predetermined threshold.

In certain embodiments, a joint protection and energy dissipation system is provided for humanoid robots, where upper and lower deformable members limit hyperextension by contacting each other when the joint (e.g., elbow) exceeds a predetermined angle, typically between 5 and 20 degrees. Additionally, an elbow energy attenuation member is configured to compress during flexion, beginning compression once the elbow joint surpasses approximately 80 degrees and reaching full compression at 135 to 160 degrees of flexion. This attenuation member can comprise an outer rim with a first density and a first compression/deflection ratio, and an inner mesh with a second density and a second ratio that are at least 50% lower than those of the outer rim, ensuring graduated energy absorption. In some embodiments, the outer rim fully surrounds the inner mesh, and both the rim and mesh compress to attenuate impact forces during full flexion. These principles can be applied to other joints, such as the knee, where upper and lower knee energy attenuation members may contact each other when flexion exceeds 110 degrees and fully compress between 150 and 180 degrees. Manufacturing methods may involve selecting materials of differing densities for each component (e.g., a first material for the upper/lower deformable members, and second and third materials for the rim and mesh) to achieve the desired compression/deflection ratios. The system optionally incorporates an actuator (e.g., a strain wave gearbox with a brushless DC motor) positioned such that its rotational axis is substantially centered in the housing, forming a gap of over 0.25 inches (or 0.635 centimeters) between housings in the fully flexed position. If excessive pressure (e.g., exceeding 250 N/cm²) is detected against an object during movement, the robot halts further joint rotation, thereby reducing the risk of damaging impacts.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A is a perspective view of a humanoid robot in an upright, neutral position and including: (i) an upper region having: (a) a head and neck assembly, (b) a torso, (c) left and right shoulders, (d) left and right upper arm assemblies that each include an upper humerus, lower humerus, upper forearms, and lower forearms, (c) left and right wrists, and (f) left and right hands; (ii) a lower region having left and right lower leg assemblies that each include (a) left and right shins, (b) left and right ankle assemblies, and (c) left and right feet; and (iii) a central region connecting the upper portion and the lower portion to one another and having (a) a spine, (b) a pelvis, (c) left and right upper leg assemblies that each include left and right hips, left and right upper thighs, and left and right lower thighs;

FIG. 1B is a perspective view of the humanoid robot of FIG. 1A, wherein said robot includes a rotation limiting system that includes an elbow portion and a knee portion;

FIG. 2 is an exploded view of the upper arm assembly of the robot of FIG. 1A, showing an elbow portion of the rotation limiting system that comprises: (i) an elbow protective assembly having deformable members, and (ii) an elbow dissipation assembly having an energy attenuation member;

FIG. 3A is a front perspective view of the upper arm assembly in an initial position and showing the elbow dissipation assembly;

FIG. 3B is a rear perspective view of the upper arm assembly in the initial position and showing the elbow protective assembly;

FIG. 4 is a top view of the upper arm assembly in the initial position, showing both the elbow protective assembly and the elbow dissipation assembly;

FIG. 5 is a zoomed-in top view of an extent of the upper arm assembly in FIG. 4;

FIG. 6 is a top view of the upper arm assembly of FIG. 1A, wherein said upper arm is in a fully flexed position and showing the elbow energy attenuation member is fully compressed;

FIG. 7 is a top view of the upper arm assembly of FIG. 1A, wherein the upper arm assembly is in a hyperextended position and the deformable members are in contact with one another;

FIG. 8 is a rear view of the upper arm assembly in the hyperextended position and said deformable members are in contact with one another;

FIG. 9 is an exploded view of a proximal extent of a leg assembly of the robot of FIG. 1A, wherein said proximal extent includes a hip, an upper thigh, a lower thigh, and a shin;

FIG. 10 is a side view of the proximal extent of the leg assembly in an initial position and showing a knee portion of the rotation limiting system including: (i) a knee protective assembly having deformable members, and (ii) a knee dissipation assembly having energy attenuation members;

FIG. 11 is a rear perspective view of the extent of the lower region in an initial position and primarily showing the knee dissipating assembly;

FIG. 12 is a rear view of the extent of the lower region in the initial position and showing the knee dissipating assembly;

FIG. 13 is a bottom perspective view of the energy attenuation members of said knee dissipating assembly;

FIG. 14 is a side view of the proximal extent of the leg assembly in the initial position;

FIG. 15 is a side view of the proximal extent of the leg assembly shown in a partially flexed position, showing the knee energy attenuation members in contact with one another but not compressed;

FIG. 16 is a side view of the proximal extent of the leg assembly in a fully flexed position, showing the knee energy attenuation members fully compressed;

FIG. 17 is a side view of the proximal extent of the leg assembly in a hyperextended position, showing said deformable members in contact with one another;

FIG. 18 is a front perspective view of the proximal extent of the leg assembly in the hyperextended position, showing said deformable members in contact with one another; and

FIG. 19 is a front view of the proximal extent of the leg assembly in the hyperextended position, showing said deformable members in contact with one another.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively highlevel, without detail, in order to avoid unnecessarily obscuring aspects of the present disclosure.

While this disclosure includes several embodiments in many different forms, there are embodiments shown in the drawings and described herein in detail with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and several details are capable of being modified, all without departing from the scope of the disclosed methods and systems. For example, one or more of the following embodiments, in part or in whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts, and detailed description are to be regarded as illustrative in nature, not restrictive or limiting.

### A. Introduction

The rotation limiting system includes components that are made from energy absorbing material(s) and are designed to: (i) help ensure that the actuator and/or the portion of the robot does not over-rotate in either direction, (ii) reduce pinch points associated with the portion of the robot, and (iii) allow the robot to have a more human-like appearance. The rotation limiting system includes: (i) an elbow portion of the rotation limiting system, and (ii) a knee portion of the rotation limiting system. The elbow rotation limiting system is further comprised of: (i) an elbow protective assembly having deformable members, and (ii) an elbow energy dissipation assembly, or elbow dissipation assembly, having an energy attenuation member. Meanwhile, the knee rotation limiting system comprises: (i) a knee protective assembly having deformable members, and (ii) a knee energy dissipation assembly, or knee dissipation assembly, having energy attenuation members.

The combination of the elbow energy dissipation assembly and knee energy dissipation assembly forms an internal energy management assembly that is positioned between two portions of the robot when the joint is in flexion. As stated above, the elbow and knee energy dissipation assemblies include energy attenuation members, and specifically an elbow energy attenuation member, an upper knee energy attenuation member, and a lower knee energy attenuation member. The combination of the energy attenuation members (e.g., elbow and knec) forms an energy attenuation assembly. As such, the internal energy management assembly includes the energy attenuation assembly. Thus, the energy attenuation members of the energy attenuation assembly may be coupled to: (i) a frontal region of the lower humerus, and/or (ii) a rear region of the lower thigh and shin. As such, each joint (e.g., elbow or knee) energy dissipation assembly may include one component or a plurality of components (e.g., between 2 and 50 components).

The combination of the elbow protective assembly and knee protective assembly forms an external motion restriction assembly that is positioned between two portions of the robot when the joint is in extension. As stated above, the elbow and knee protective assemblies include deformable members, and specifically upper and lower elbow deformable members, and upper and lower knee deformable members. The combination of the deformable members forms a deformable assembly. As such, the external motion restriction assembly includes the deformable assembly. Thus, the deformable members of the deformable assembly may be coupled to: (i) a rear region of the lower humerus and upper forearm, and/or (ii) a front region of the lower thigh and shin. As such, each joint (e.g., elbow or knee) protective assembly may include one component or a plurality of components (e.g., between 2 and 50 components). Based on the above, a joint may include only one of the protective assembly or the energy dissipation assembly. In other words, a joint may: (i) only include a protective assembly, (ii) only include an energy dissipation assembly, or (iii) include both a protective assembly and an energy dissipation assembly.

The components contained in: (i) the rotation limiting system, (ii) the external motion restriction assembly and internal energy management assembly, and/or (iii) the deformable assembly and energy attenuation assembly may be sacrificial parts that can be replaced when they break. Certain components contained in the external motion restriction assembly or the deformable assembly may be made from plastic and can have a first density and a first compression/deflection ratio, while certain components contained in the internal energy management assembly or the energy attenuation assembly may include urethane and can have a second density and a second compression/deflection ratio. The disclosed second density and second compression/deflection ratio may be less, and in certain situations, substantially less (e.g., more than 50%), than the first density and first compression/deflection ratio.

In other embodiments, certain components contained in the internal energy management assembly or the energy attenuation assembly may include two regions: a first region having a first region density and a first region compression/deflection ratio, and a second region having a second region density and a second region compression/deflection ratio. The second region density and second region compression/deflection ratio are greater than the first region density and first region compression/deflection ratio. In this embodiment, the second region is positioned adjacent to the panel, frame, or housing and is surrounded, or partially surrounded, by the first region.

The components contained in the (i) rotation limiting system, (ii) external motion restriction assembly and internal energy management assembly, and/or (iii) deformable assembly and energy attenuation assembly may be made using any known method, including injection molding, 3D printing/additive manufacturing, or subtractive manufacturing. Due to the deformable nature of the components contained in the rotation limiting system, the components may be supported by reinforced removable housing panels, added bracing contained in existing housings, end stop mounts, or other aspects of the housings. In other embodiments, the dissipating assembly may be integrally formed with a panel, housing, frame, or another extent of the robot. Also, while the figures only show the dissipating assembly used in connection with the elbow and knee joints, it should be understood that the dissipating assembly may be used in connection with any joint (e.g., fingers, thumb, wrist, shoulder, hips, ankle, any combination thereof, or other known joints).

The preferred arrangement of components of the elbow includes an elbow actuator positioned within an extent of a first assembly, or lower humerus, and a second assembly, or upper forearm. By positioning the actuator within the lower humerus and the upper forearm, the housings associated with the lower humerus and upper forearm can protect and house the actuator. In other words, the elbow actuator lacks a separate elbow actuator housing that is separate from the housings of the lower humerus and upper forearm. This is beneficial over conventional robots that lack this feature because it reduces space and weight.

Unlike conventional robot elbows, the disclosed elbow includes: (i) a lower forearm assembly that is directly coupled to a single side of the arm, specifically the output of the elbow actuator, (ii) a lower humerus assembly and a lower forearm assembly that have substantially round cross-sections in at least one location, (iii) a lower forearm diameter that is slightly less than a lower humerus diameter, which enables the arm to have a slightly tapered look, (iv) a rotational axis located at an actuator pivot point (in other words, the actuator is not disposed in a location that is distant from the elbow joint's axis of rotation), (v) a rotational axis that is slightly offset forward from the rotational axes of the upper humerus and the lower forearm, (vi) an elbow rotational axis that is substantially centered between opposing points of the housing of the upper humerus assembly and the lower forearm assembly, wherein substantially means within 10 mm of being centered, (vii) a lower humerus assembly lacking a recess designed to receive an extent of the actuator when the arm is in a fully flexed position, (viii) a mechanism that will cause the elbow actuator to stop compressing if a pressure applied to an external object is over a predefined controlled amount (e.g., 250 N/cm²), and (ix) a structural design that prevents the elbow from applying a pressure that is over a second predefined amount or a limiting pressure (e.g., 300 N/cm²) to an external object. Overall, each of these features of the disclosed elbow provides substantial benefits (e.g., human form factor, range of motion, durability, manufacturability, replicability, modularity) over conventional robot elbows.

The elbow actuator (J4) is designed to move the robot's second assembly, or the upper forearm, from a hyperextended position, to a normal or initial position, and then to a flexed position. The disclosed arm includes a range of motion greater than 80 degrees, preferably greater than 120 degrees, and most preferably between 140 degrees and 160 degrees. This range of motion allows the arm assembly to be placed in flexion between 1-140 degrees and hyperflexion between 1 and 20 degrees.

Moreover, the arm assembly (including the upper humerus, lower humerus, upper forearm, and lower forearm) lacks linear actuator(s), or hydraulic, cable-based, or pneumatic actuator(s). Additionally, the disclosed elbow joint does not include linkages or linear actuators. Instead, the arm assembly, and specifically the elbow joint, only includes rotary actuators having strain wave gearboxes with brushless DC motors. This design not only reduces the components contained in the elbow joint, provides for greater control over the elbow, simplifies the design of the elbow and its adjoining structures, and reduces torques, stresses, and strain that are placed on other structures in the robot's arm due to the lack of linkages, but it also simplifies the manufacturing and assembly of the robot. Each of these benefits provides a substantial advantage to the disclosed robot over conventional robots.

The preferred arrangement of components of the knee includes a knee actuator positioned within an extent of a first assembly, or lower thigh, and a second assembly, or shin. By positioning the actuator within the lower thigh and the shin, the housings associated with the lower thigh and the shin can protect and house the actuator. In other words, the knee actuator lacks a separate knee actuator housing. This is beneficial over conventional robots that lack this feature because it reduces space and weight.

As shown in the Figures, the disclosed knee includes: (i) a shin assembly that is directly coupled to a single side of the leg, specifically the output of the knee actuator, (ii) a lower thigh assembly and a shin assembly that have substantially round cross-sections in at least one location, (iii) a shin diameter that is less than a lower thigh diameter, which enables the leg to have a slightly tapered look, (iv) the knee actuator's rotational axis is located at a knee pivot point (in other words, the actuator is not disposed in a location that is distant from the knee joint's axis of rotation), (v) a knee rotational axis that is aligned in a vertical plane with the rotational axes of the hip (J11) and leg twist (J13), (vi) a knee rotational axis that is substantially centered between opposing points of the housings of the lower thigh and the shin, wherein substantially means within 10 mm of being centered, (vii) neither the lower thigh assembly nor the shin assembly includes a recess that is designed to receive an extent of the actuator when the leg is in a fully flexed position, (viii) a mechanism that prevents the knee from applying a pressure on an external object that is greater than a predefined control pressure (e.g., 250 N/cm²), and (ix) a structural configuration that enables the knee not to apply a pressure that is over a predefined limiting pressure (e.g., 300 N/cm²) to an external object. Overall, each of these features of the disclosed knee/lower leg provides substantial benefits (e.g., human form factor, range of motion, durability, manufacturability, replicability, modularity) over conventional robot knees/lower legs.

In particular, the knee actuator (J14) is designed to move the robot's shin from a hyperextended position, to a normal or initial position, and to a flexed position. The knee's range of motion ranges from −1 to −180 degrees (flexed) to normal at 0 degrees, and to 1 and 20 degrees (hyperextended). In other words, the total range of motion of the knee is greater than 80 degrees, preferably greater than 120 degrees, and most preferably between 150 degrees and 180 degrees.

Moreover, the leg assembly (including the hip, an upper thigh, a lower thigh, shin, talus, and feet) lacks hydraulic, cable-based, or pneumatic actuator(s). Additionally, the disclosed knee does not include linkages or linear actuators. Instead, the disclosed knee utilizes a rotary actuator with a brushless DC motor and a strain wave gearbox. This design not only reduces components contained in the knee, provides for greater control over the knee, simplifies the design of the knee and its adjoining structures, and reduces torques, stresses, and strain that are placed on other structures in the robot's leg due to the lack of linkages, but it also simplifies the manufacturing and assembly of the robot. Each of these benefits provides a substantial advantage to the disclosed robot over conventional robots.

### B. Robot

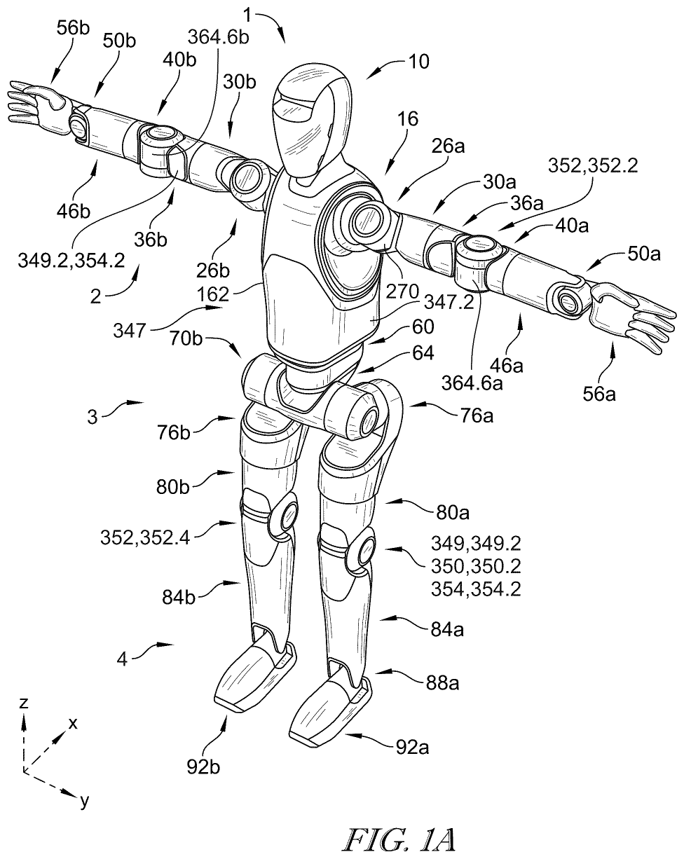

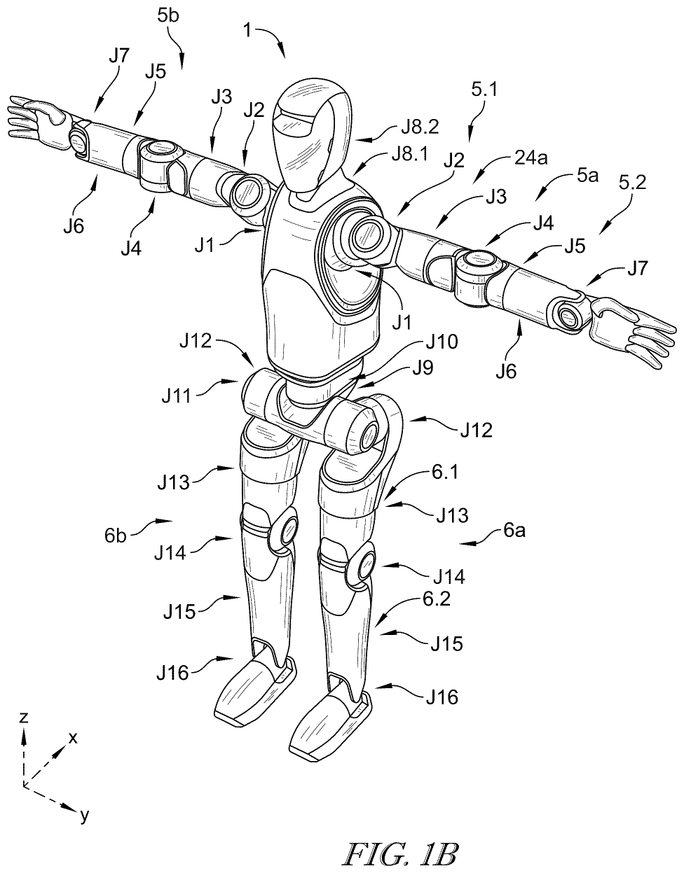

Referring to FIGS. 1A-1B, a humanoid robot 1 may include the following systems, assemblies, components, and/or parts: (i) an upper region 2 including a head/neck 10, a torso 16, left and right arms 5, and left and right hands 56; (ii) a central region 3 including a spine 60, a pelvis 64, and left and right upper leg assemblies 6.1, with each upper leg assembly 6.1 including a hip 70, an upper thigh 76, and a lower thigh 80; and (iii) a lower region 4 including left and right lower leg assemblies 6.2, with each lower leg assembly 6.2 including a shin 84, a talus 88, and feet 92. Each arm 5 includes an upper arm 5.1 including a shoulder 26, an upper humerus 30, a lower humerus 36; and a lower arm 5.2 including an upper forearm 40, a lower forearm 46, and a wrist 50. Each leg 6 includes an upper leg assembly 6.1 and a lower leg assembly 6.2. Finally, as illustrated in some drawings, a proximal extent of the leg assembly 6 includes the upper leg assembly 6.1 (e.g., the hip 70, the upper thigh 76, the lower thigh 80) and the shin 84.

The robot 1 includes various actuators arranged within the robot 1 to closely replicate human movements and capabilities. In the illustrative embodiment, the left and right arms 5 extend from the torso 16 of the robot 1. The actuators in the upper arm 5.1 include: (i) a shoulder actuator (J2) 280 configured to move the arm relative to the robot's torso 16, (ii) an upper arm twist actuator (J3) 320 configured to rotate the arm 5 relative to the robot's torso 16, and (iv) an elbow actuator (J4) 374 configured to bend or flex the elbow or arm of the robot 1. The lower arm 5.2 includes a lower arm twist actuator (J5) 468, a wrist pitch actuator (J6) 484, and a wrist pivot actuator (J7) 520. The arm actuator (J1) 190 contained in the torso 16 and the actuators (J2-J7) contained in the arm assembly cooperate to position the hand 56 coupled to the wrist 50.

Further in the illustrative embodiment, the left and right legs 6 extend from the pelvis 64 of the robot 1. The actuators in the upper leg assembly 6.1 include: (i) a hip flex actuator (J11) 720 configured to move the leg 6 forward and backward relative to the robot's torso 16, (ii) a hip pivot actuator (J12) 768 configured to move the leg 6 sideways (e.g., to the left or right) relative to the robot's torso 16, (iii) a leg twist actuator (J13) 782 configured to rotate the leg 6 relative to the robot's torso 16, and (iv) a knee actuator (J14) 820 configured to bend the knee or leg of the robot 1. The lower leg assembly 6.2 includes a foot flex actuator (J15) 860 configured to change the pitch of the foot 92 and a foot roll actuator (J16) 900 configured to roll the foot 92.

Below is a summary table showing the actuator reference names and numbers, actuator names, and associated components from the high level configuration of the robot 1. In particular, the actuator bearing of individual actuators may help define the motion of the component or structure attached to the output driven by the individual actuators.

TABLE 1

| | | | Actuator Bearing |
|---|---|---|---|
| | | | Plane B, and |
| | | | (Actuator |
| Actuator | Actuator Name | Actuator Axis | Bearings) |
| J1 | Arm Actuator | Arm Axis, A₁ | B₁ |
| (190) | | | (194.12) |
| J2 | Shoulder Actuator | Shoulder Axis, A₂ | B₂ |
| (280) | | | (284.6) |
| J3 | Upper Arm Twist, Upper Arm | Upper Arm Twist, Upper Arm | B₃ |
| (320) | X, or Upper Arm Roll Actuator | X, or Upper Arm Roll Axis, A₃ | (324.6) |
| J4 | Elbow, Arm Z, Arm Yaw, or | Elbow, Arm Z, Arm Yaw, or | B₄ |
| (374) | Lower Humerus Actuator | Lower Humerus Axis, A₄ | (378.6) |
| J5 | Lower Arm Twist, Lower Arm | Lower Arm Twist, Lower Arm | B₅ |
| (468) | X, or Lower Arm Roll Actuator | X, or Lower Arm Roll Axis, A₅ | (472.6) |
| J6 | Wrist Flex, Wrist/Hand Y, | Wrist Flex, Wrist/Hand Y, | B₆ |
| (484) | Wrist/Hand Pitch, or Flick | Wrist/Hand Pitch, or | (488.6) |
| | Actuator | Flick Axis, A₆ | |
| J7 | Wrist Pivot, Wrist/Hand Z, | Wrist Pivot, Wrist/Hand Z, | B₇ |
| (520) | Wrist/Hand Yaw, or Wave | Wrist/Hand Yaw, or | (524.6) |
| | Actuator | Wave Axis, A₇ | |
| J8.1 | Head Twist, Head No, or | Head Twist, Head No, or | B_{8.1} |
| (120) | First Head Actuator | First Head Axis, A_{8.1} | (124.6) |
| J8.2 | Head Nod, Head Yes, or | Head Nod, Head Yes, or | B_{8.2} |
| (140) | Second Head Actuator | Second Head Axis, A_{8.2} | (144.6) |
| J9 | Torso Lean, Spine X, | Torso Lean Actuator, Spine X, | B₉ |
| (680) | Torso/Spine Roll, or First Spine | Torso/Spine Roll, or | (684.6) |
| | Actuator | First Spine Axis, A₉ | |
| J10 | Torso Twist, Spine Z, | Torso Twist, Spine Z, | B₁₀ |
| (620) | Torso/Spine Yaw, or Second | Torso/Spine Yaw, or Second | (624.6) |
| | Spine Actuator | Spine Axis, A₁₀ | |
| J11 | Hip Flex, Hip Y, Hip/Leg Pitch, | Hip Flex, Hip Y, Hip/Leg Pitch, | B₁₁ |
| (720) | Forward Kick, or First Hip | Forward Kick, or | (724.6) |
| | Actuator | First Hip Axis, A₁₁ | |
| J12 | Hip Pivot, Hip X, Hip/Leg Roll, | Hip Pivot, Hip X, Hip/Leg Roll, | B₁₂ |
| (768) | Sideways Kick, or Second Hip | Sideways Kick, or | (772.6) |
| | Actuator | Second Hip Axis, A₁₂ | |
| J13 | Leg Twist, Hip Z, or | Leg Twist, Hip Z, or Hip/Leg | B₁₃ |
| (782) | Hip/Leg Yaw Actuator | Yaw Axis, A₁₃ | (786.6) |
| J14 | Knee, Lower Thigh, Lower Leg | Knee, Lower Thigh, Lower Leg | B₁₄ |
| (820) | Y, Lower Leg Pitch, or Rear | Y, Lower Leg Pitch, or | (824.6) |
| | Kick Actuator | Rear Kick Axis, A₁₄ | |
| J15 | Foot Flex, Foot Y, | Foot Flex, Foot Y, Foot Pitch, | N/A |
| (860) | Foot Pitch, or First Ankle | or First Ankle Axis, A₁₅ | |
| | Actuator | | |
| J16 | Talus, Foot Roll, Foot X or | Talus, Foot Roll, Foot X or | B₁₆ |
| (900) | Second Ankle Actuator | Second Ankle Axis, A₁₆ | (904.6) |

The table below identifies the actuator, the maximum and minimum angles that the actuator can rotate to, and the associated ranges of motion that extend between the max and min angles. It should be understood that the below angles and ranges of motion are exemplary and are provided to show the robot's 1 ability to not only have a significant number of degrees of freedom (e.g., 60), but each degree of freedom is associated with a significant range of motion. This is in contrast to conventional robots that lack these large ranges of motion, which prevents the conventional robots from completing the complex humanlike tasks that the disclosed robot 1 can perform.

TABLE 2

| | | | | Preferred | Preferred | Preferred |
|---|---|---|---|---|---|---|
| | First | Second | Range of | First | Second | Range of |
| Actuator | Angle | Angle | Motion | Angle | Angle | Motion |
| J1 | −162 | 108 | 270 | −148.5 | 99 | 247.5 |
| J2 | −129 | 48 | 177 | −118.8 | 44 | 162.8 |
| J3 | −144 | 144 | 288 | 132 | 132 | 264 |
| J4 | −162 | 18 | 180 | −148.5 | 16.5 | 165 |
| J5 | −180 | 180 | 360 | −175 | 175 | 350 |
| J6 | −54 | 54 | 108 | −49.5 | 49.5 | 99 |
| J7 | −108 | 108 | 216 | −99 | 99 | 198 |
| J8.1 | −108 | 108 | 216 | −99 | 99 | 198 |
| J8.2 | −30 | 30 | 60 | −27.5 | 27.5 | 55 |
| J9 | −36 | 36 | 72 | −33 | 33 | 66 |
| J10 | −108 | 108 | 216 | −99 | 99 | 198 |
| J11 | −192 | 42 | 234 | −176 | 38.5 | 214.5 |
| J12 | −30 | 54 | 84 | −27.5 | 49.5 | 77 |
| J13 | −108 | 108 | 216 | −99 | 99 | 198 |
| J14 | −18 | 174 | 192 | −16.5 | 159.5 | 176 |
| J15 | −72 | 48 | 120 | −66 | 44 | 110 |
| J16 | −54 | 54 | 108 | −49.5 | 49.5 | 99 |

It is understood that the number/location of actuators, range of motion, and/or arrangement of axes of rotation associated with the disclosed humanoid robot materially and substantially differ from the number/location of actuators, range of motion, and/or arrangement of axes of rotation for a non-humanoid robot. As such, the structures, number/location of actuators, range of motion, and/or arrangement of axes of rotation associated with a non-humanoid robot cannot be simply adopted or implemented into a humanoid robot without careful analysis and verification of the complex realities of designing, testing, and manufacturing a general-purpose humanoid robot. Theoretical designs that are an attempt to implement such modifications from a non-humanoid robot are insufficient (and in some instances, woefully insufficient) because they amount to mere design exercises that are not tethered to the complex realities of successfully designing, testing, and manufacturing a general-purpose humanoid robot.

The placement and torque of the different types of actuators for robot 1 are outlined in the table below. In light of the below table, the robot 1 may include an actuator having a momentary peak torque that is between 70 and 500 N-m. In alternative embodiments, the various actuator types may be arranged differently within the alternative robot (e.g., J1 or J12 may be assigned a different actuator type) and/or different torques may be selected for the actuator types, while keeping the commonality of the actuators to reduce the number of unique parts.

TABLE 3

| Actuator | | | |
|---|---|---|---|
| Type | Actuator | Momentary Peak Torque (N-m) | Preferred Momentary Peak Torque (N-m) |
| 1 | J11 (720) | 265-498 | 298-365 |
| | J14 (820) | | |
| 2 | J9 (680) | 101-152 | 114-139 |
| | J10 (620) | | |
| | J12 (768) | | |
| | J13 (782) | | |
| 3 | J1 (190) | 72-109 | 81-100 |
| | J2 (280) | | |
| | J3 (320) | | |
| | J4 (374) | | |
| 4 | J16 (900) | 96-144 | 108-132 |
| 5 | J5 (468) | 17-26 | 19-24 |
| | J6 (484) | | |
| | J7 (520) | | |
| 5a | J8.1 (120) | 72-109 | 81-100 |
| | J8.2 (140) | | |
| 6 | J15 (860) | 96-144 | 108-132 |
| | linear | | |
| 7 | Hands | 3-4 | 3.5-4.5 |

### C. Rotation Limiting System

The rotation limiting system 350 includes components that are made from energy absorbing material(s) and are designed to: (i) help ensure that the actuator and/or the portion of the robot 1 does not over-rotate in either direction, (ii) reduce pinch points associated with the portion of the robot 1, and (iii) allow the robot 1 to have a more human-like appearance. The rotation limiting system 350 includes: (i) an elbow portion of the rotation limiting system 350.2, and (ii) a knee portion of the rotation limiting system 350.4. It should be understood that other portions may be added to the system 350. For example, said additional portions may include hips, underarms/upper torso, fingers, and wrist. In further embodiments, the elbow portion or the knee portion may be omitted.

The elbow portion 350.2 of the rotation limiting system 350 further comprises: (i) an elbow protective assembly 352.2 having deformable members 365, 405, and (ii) an elbow energy dissipation assembly, or elbow dissipation assembly, 354.2 having an energy attenuation member 368. Meanwhile, the knee portion 350.4 of the rotation limiting system 350 comprises: (i) a knee protective assembly 352.4 having deformable members 805.2, 845.2, and (ii) a knee energy dissipation assembly, or knee dissipation assembly, 354.4 having energy attenuation members 808, 848.

The combination of the elbow energy dissipation assembly 354.2 and knee energy dissipation assembly 354.4 forms an internal energy management assembly 349 that is positioned between two portions of the robot 1 when the joint is in flexion. As stated above, the elbow and knee energy dissipation assemblies 354.2, 354.4 include energy attenuation members 368, 808, 848, and specifically an elbow energy attenuation member 368, an upper knee energy attenuation member 808, and a lower knee energy attenuation member 848. The combination of the energy attenuation members 368, 808, 848 (e.g., located at the elbow and knee, respectively) forms an energy attenuation assembly 349.2. As such, the internal energy management assembly 349 includes the energy attenuation assembly 349.2, among other components. Thus, the energy attenuation members 368, 808, 848 of the energy attenuation assembly 349.2 may be coupled to: (i) a frontal region 391 of the lower humerus 36, and/or (ii) a rear region 819 of the lower thigh 80 and shin 84. As such, each joint (e.g., elbow or knee) energy dissipation assembly may include one component or a plurality of components (e.g., between 2 and 50 components).

### D. Elbow Assembly

Referring to FIGS. 1-8, the elbow assembly includes the lower humerus 36, the upper forearm 40, and the elbow actuator assembly (J4) 374 coupled therebetween. Each of the lower humerus 36 and the upper forearm 40 is configured to couple with a portion of the elbow actuator assembly (J4) 374; however, neither is configured in this embodiment to fully house any of the actuators. The housings 362, 402 of the lower humerus 36 and the upper forearm 40 are coupled at the elbow actuator (J4) 374, such that an extent of the lower humerus 36 abuts and rotates with respect to an extent of the upper forearm 40. As such, the elbow actuator (J4) 374 is supported on a single side of the actuator by each of the lower humerus 36 and the upper forearm 40. In other words, neither the lower humerus 36 nor the upper forearm 40 provide support on both sides of the elbow actuator (J4) 374.

a. Lower Humerus

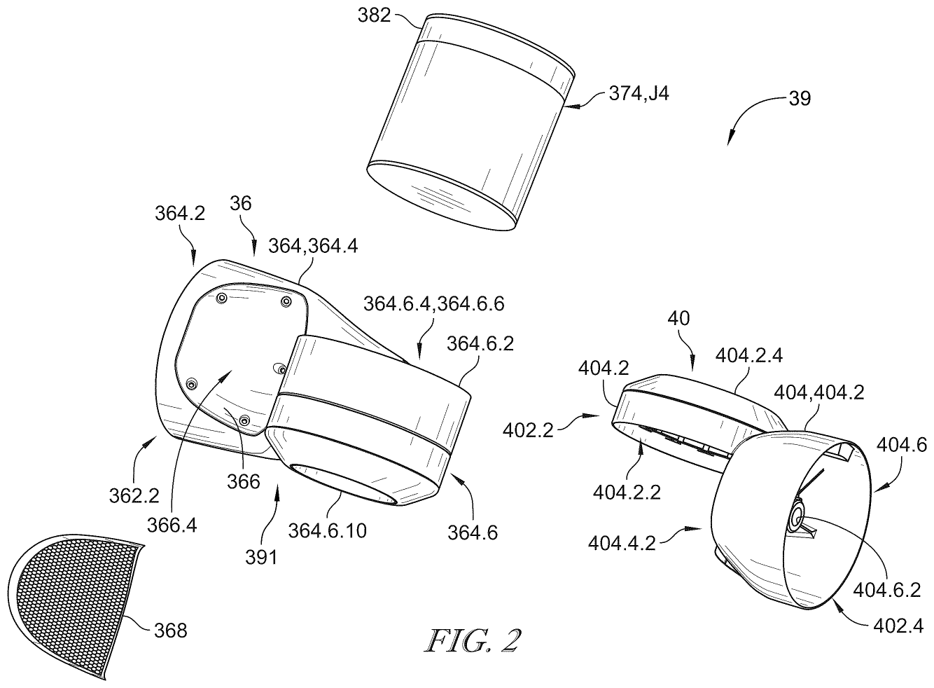

As shown in FIGS. 2-8, the lower humerus 36 is configured to be coupled to the output adapter of the arm twist actuator (J3) 320. The coupling of said lower humerus 36 to the output adapter enables said arm twist actuator (J3) 320 to rotate the rest of the arm 5 about the A₃ axis. The lower humerus 36 may include (i) a housing 362 having a frame 364, and (ii) an extent of the elbow actuator assembly (J4) 374. The housing 362 includes a frame 364 and an internal elbow cover 366. The housings 362a, 362b of the left and right lower humerus 36a, 36b are each coupled to the respective arm twist actuators (J3) 320 in the upper humerus 30 in mirrored positions such that the arms each bend inward at the elbow toward the front of the torso 16. Although the left and right housings 362a, 362b have the same structure (i.e., are interchangeable for either side), each is coupled to the respective arm twist actuator (J3) 320 and positioned such that the elbow actuator receiving assembly 364.6 of the housing 362 is inverted with respect to the left and right sides 362a, 362b, such that when coupled within the respective frames 364, the output of the elbow actuators (J4) 374 are in opposite rotational directions. For example, the left lower humerus housing 362a may be positioned such that the elbow actuator receiving assembly 364.6a is positioned downward to receive the elbow actuator (J4) 374 from the top, whereas the right lower humerus housing 362b may be positioned such that the elbow actuator receiving assembly 364.6b is positioned upward to receive the elbow actuator (J4) 374 from the bottom (FIG. 1A). The same configurations for the left and right lower humerus housings 362a, 362b are used for simplicity and to minimize part count.

Referring to FIGS. 2-8, the frame 364, and as such the housing 362, includes an access opening 364.4.4.2 formed in a sidewall portion 364.4.4 to access the lower humerus input mount and secure said mount to the upper humerus output mount via a coupling means (e.g., one or more fasteners-namely threaded fasteners, projections, snap-fit connectors, bayonet mounts, pin-and-hole connections, press-fit/interference fits, clamp or clip mechanisms, magnets, hook-and-loop fasteners, rivets, ball detents, hinge joints, sliding rails, cam locks, toggle clamps, quick-release pins, spring-loaded connectors, wedge locks, dowel pins, ratchet mechanisms, T-slot connectors, twist locks, latches, locking tabs, etc.). An internal elbow cover 366 may be removably coupled to the frame 364 or the housing 362 to cover the access opening 364.4.4.2 and reinforce the housing 362 at the access opening 364.4.4.2. For example, the internal elbow cover 366 may be coupled to the housing 362 by the interaction between the coupling means (e.g., threaded fasteners or any other coupling structure disclosed herein) and mounting features 364.4.4.2.2 of the access opening 364.4.4.2. The interior surface 366.2 of the cover 366 includes ribs 366.2.2 to increase the stiffness of said cover 366. In other embodiments, the ribs 366.2.2 may be omitted, their thickness may be increased, or fewer ribs may be used. Additionally, it should be understood that in other embodiments, the cover 366 may be omitted and instead may be integrally formed as a part of the frame 364. The exterior surface 366.4 of the cover may include or be coupled to an elbow energy attenuation member 368 configured to absorb energy. It should be understood that other locations and other methods of accessing said coupling means and mount are contemplated by this disclosure. For example, a longitudinal split in the frame 364 may provide said access.

b. Upper Forearm

As shown in FIGS. 2-8, the upper forearm 40 includes a housing 402 having a frame 404. The frame 404 includes (i) an upper forearm coupling assembly 404.2 having an upper forearm input mount 404.2.2 and an actuator cover 404.2.4, and (ii) an upper forearm extender 404.4. The upper forearm 40 provides a transition between the upper arm assembly 24 and the lower forearm 46, wrist 50, and hand 56. The upper forearm coupling assembly 404.2 includes a portion of the housing 402 that is substantially circular in shape with a substantially circular coupling wall portion 404.6.2. As such, said upper forearm coupling assembly 404.2 includes an exterior surface that has a curvilinear extent and a U-shaped portion that is positioned in the X-Y plane. Said upper forearm coupling assembly 404.2 may be coupled to the upper forearm output mount 382 of the elbow actuator assembly (J4) 374. The upper forearm coupling assembly 404.2 can have a cover opening 404.2.6 suitable to provide access to the upper forearm input mount 404.2.2 to secure the upper forearm output mount 382 to said upper forearm input mount 404.2.2 using a coupling means (e.g., threaded fasteners or any other coupling structure disclosed herein).

c. Elbow Actuator

As shown in FIGS. 2-8, the elbow actuator (J4) 374 is coupled between the lower humerus 36 and the upper forearm 40. The elbow actuator receiving assembly 364.6 of the lower humerus frame 364 is configured to house a majority of the elbow actuator assembly (J4) 374. Said elbow actuator receiving assembly 364.6 extends from the lower humerus extender 364.4 and is configured to be positioned adjacent to the housing 402 of the upper forearm 40. The elbow actuator receiving assembly 364.6 may include: (i) an actuator receptacle 364.6.2, (ii) a lower humerus actuator mount 364.6.4, (iii) a forearm opening 364.6.6, (iv) a cover opening, and (v) an actuator cover 364.6.10. The frame 364 may be formed such that the elbow actuator assembly (J4) 374 is received into the actuator receptacle 364.6.2 via the forearm opening 364.6.6 and secured therein to the lower humerus actuator mount 364.6.4. The cover opening 364.6.8 formed opposite the forearm opening 364.6.6 may provide access to the elbow actuator assembly (J4) 374. The actuator cover 364.6.10 can be detachably attached to enclose the housing.

The elbow actuator assembly 374 is configured to be coupled to the frame 364 of the lower humerus 36 within the elbow actuator receiving assembly 364.6. The upper forearm housing 402 includes a coupling assembly 404.2 that engages the output of the elbow actuator (J4) 374. The upper forearm coupling assembly 404.2 may include an upper forearm input mount configured to cooperate with the lower humerus output adapter and accessible via the cover opening 404.2.6 covered by a removable cover 404.2.4. Together, the elbow actuator receiving assembly 364.6 of the lower humerus housing 362 and the coupling assembly 404.2 of the upper forearm housing 402 enclose the elbow actuator (J4) 374.

It should be noted that the elbow actuators (J4) may utilize a range and/or combination of advanced motor types, including brushless DC motors, stepper motors, servo motors, coreless DC motors, synchronous AC motors, asynchronous induction motors, linear motors, piezoelectric motors, direct-drive motors, switched reluctance motors, permanent magnet synchronous motors (PMSMs), axial flux motors, and hybrid stepper motors. These motors may employ rare-earth permanent magnets, such as neodymium-iron-boron (NdFeB) alloys, samarium-cobalt (SmCo) magnets, ferrite magnets, alnico magnets, flexible magnets, bonded rare-earth magnets, and high-temperature permanent magnets, to achieve high torque density and energy efficiency. Motor windings may include high-conductivity copper wire with advanced ceramic or polyimide insulation for superior thermal and electrical performance. The motors may be coupled with various high-reduction gear mechanisms designed for precision and load handling, such as strain wave gearboxes (e.g., Harmonic drives), cycloidal reducers, planetary gearboxes, bevel gear systems, worm gears, parallel shaft helical gear mechanisms, spur gear assemblies, crossed helical gear systems, double-enveloping worm gears, herringbone gears, hypoid gears, rack-and-pinion systems, bevel hypoid gears, epicyclic gear trains, and differential gear systems. Additionally, some implementations may incorporate custom gear profiles optimized for torque transfer efficiency, backlash reduction, and noise minimization. Moreover, the mechanical gear systems' reduction ratios may be any reduction ratio, including 1:1.1 to 1:150. In particular, said reduction ratio may be 1:10, 1:20, 1:30, 1:50, and/or 1:100. In other words, said reduction ratio may be less than 1:1.1. In other embodiments, said reduction ratio may be more than 1:150. Further, said actuators may include brakes or clutches to protect the gearbox and/or to allow for power to be removed from the actuators without causing the robot 1 to fall to the ground.

Examples of these alternative combinations for the elbow actuator (J4) 374 could include a hybrid stepper motor combined with a cycloidal drive. This combination could achieve reduction ratios (1:30 to 1:87), which may be a good compromise between speed and force. Additionally, to achieve exceptional positional accuracy and ensure reliable operation, each motor may be equipped with advanced encoders, which could be optical, magnetic, capacitive, inductive, resistive, piezoelectric, hall-effect, potentiometric, or ultrasonic. These encoders may facilitate sub-millimeter-level accuracy, critical for applications requiring meticulous movement control. To complement positional data, said actuator may include integrated torque sensors that have strain gauges, piezoresistive sensors, magnetoclastic sensors, capacitive sensors, fiber-optic sensors, or rotary transformers. Additionally or alternatively, the actuators may include current sensors, such as Hall-effect sensors, shunt resistors, fluxgate sensors, Rogowski coils, or magnetoresistive sensors. Furthermore, the system may incorporate micro-electromechanical systems (MEMS) gyroscopes and/or accelerometers, which provide additional sensory data related to orientation, angular velocity, and linear acceleration. This sensory integration enhances the robot's ability to navigate complex environments and maintain stability during operation.

Further, the actuators or the output of the actuators may include bearing housings constructed using advanced materials like carbon-fiber-reinforced polymers (CFRPs), fiberglass-reinforced polymers (FRPs), metal alloys, polyetheretherketone (PEEK), thermoplastic composites, and ultra-high-molecular-weight polyethylene (UHMWPE). Additionally, the manufacturing processes for CFRPs, such as filament winding or automated fiber placement, allow for precise control over fiber orientation, further optimizing the mechanical performance of the housings. The bearings themselves can be fabricated from, include, or be processed using high-grade steel alloys (e.g., AISI 52100, M50, or 440C stainless steel), high-performance nickel-based superalloys (e.g., Inconel 718 or Hastelloy), cobalt-based alloys (e.g., Stellite), advanced ceramics (e.g., alumina or zirconia-based composites), and polymer matrix composites reinforced with carbon or aramid fibers. These materials may also benefit from advanced heat treatments (e.g., vacuum hardening or cryogenic treatment), surface engineering processes (e.g., ion implantation or physical vapor deposition), or specialized coatings.

To further optimize performance, the rolling elements of the bearings may be composed of advanced ceramic materials (e.g., silicon nitride, tungsten carbide, or zirconia), sapphire, or composite materials combining ceramic with metal or polymer matrices. In another embodiment, the assembly may incorporate cylindrical roller bearings, angular contact ball bearings, or hybrid bearings that combine steel races with ceramic rolling elements. Additionally, spherical roller bearings, tapered roller bearings, needle roller bearings, magnetic bearings, or hybrids or combinations thereof may be used. Cutting-edge manufacturing techniques, including additive manufacturing methods like selective laser melting (SLM), could be employed to create complex bearing geometries. These geometries may integrate features such as internal cooling channels, lubrication reservoirs, or textured surfaces to enhance lubrication retention and minimize wear.

The incorporation of such features allows for improved thermal management, reduced friction, and consistent lubrication distribution, even under challenging operating conditions. Additive manufacturing also enables the production of customized bearing designs with minimal material waste, aligning with sustainable manufacturing practices. In addition to additive manufacturing, other advanced processes like precision machining, laser hardening, or chemical vapor deposition (CVD) coatings may be applied to enhance the surface properties of the bearings. These techniques can improve wear resistance, reduce friction, and provide protection against corrosion, further extending the operational life of the components. The integration of smart sensors within the bearing housing is another potential enhancement, allowing for real-time monitoring of parameters such as temperature, vibration, and load. This data can be used to predict maintenance needs and prevent unexpected failures, ensuring optimal performance and reliability.

### E. Elbow Portion of the Rotation Limiting System

As shown in FIGS. 1-8, the rotation limiting system 350 of the robot 1 includes an elbow portion 350.2. Said elbow portion 350.2 of the rotation limiting system 350 includes: (i) an elbow protective assembly 352.2, and (ii) an elbow dissipating assembly 354.2. Specifically, the elbow protective assembly 352.2 is positioned in an outer region 399 of the lower humerus 36 and upper forearm 40 near the elbow actuator (J4) 374 and includes deformable members 365, 405 that are configured to protect rear portions 364.8.2, 404.8.2 of the lower humerus 36 and upper forearm 40 in a hyperextension position S_{A-HE}. The elbow dissipating assembly 354.2 is positioned in a front or inner region 391 of the lower humerus 36 and includes an elbow energy attenuation member 368 coupled to the lower humerus 36, wherein the elbow energy attenuation member 368 is configured to compress when the elbow assembly 39 is bent or flexed. The elbow dissipating assembly 354.2 includes components that are made from energy absorbing materials and is designed to: (i) help ensure that the actuator (J4) 374 does not over-rotate in either direction, (ii) reduce pinch points associated with the elbow, and (iii) allow the robot to have a more human-like appearance.

The disclosed elbow protective assembly 352.2 and elbow dissipating assembly 354.2 include disposable or sacrificial parts designed to be used for a period of time and replaced when damaged. For example, the deformable members 365, 405 and the elbow energy attenuation member 368 can be replaced if broken and are designed to protect structural members (e.g., extents of the housings) of the lower humerus 36 and upper forearm 40 and reduce safety concerns when the robot 1 is interacting with humans. These disposable or sacrificial parts are located in a position likely to receive high amounts of compression and decompression and are made from a material that resists wear and tear and is more deformable than metal. These disposable or sacrificial parts provide the elbow assembly 39 with substantial advantages over conventional elbows that lack these disposable or sacrificial parts.

The deformable members 365, 405 and elbow energy attenuation member 368 may be supported by a projection 364.8.8 or other means of mounting that are integrally formed in the respective housing 362 or panels coupled to the housing 362. For example, support for the upper and lower rear deformable members 365, 405 may be provided by a projection 364.8.8 integrally formed with the frame 364 of the lower humerus 36 and upper forearm 40. Support for the elbow energy attenuation member 368 may be provided by the internal elbow cover 366 that is removably coupled to the lower humerus 36.

As described above, the elbow actuator (J4) 374 may include internal hard stops that limit the range of motion of the elbow assembly 39. The deformable members 365, 405 and elbow energy attenuation member 368 may be used in connection with a hard stop or may replace the hard stop. In further embodiments, the deformable members 365, 405 and elbow energy attenuation member 368 may be replaced with external or internal hard stops.

The deformable members 365, 405 may be made from plastic and can have a first density and a first compression/deflection ratio, while the front elbow energy attenuation member 368 may be made from or include urethane and can have a second density and a second compression/deflection ratio. The disclosed second density and second compression/deflection ratio may be less, and in certain situations may be substantially less (e.g., more than 50%), than the first density and first compression/deflection ratio. In other embodiments, the elbow energy attenuation member 368 may include two extents, wherein a first extent or region 368.2 has a third density and a third compression/deflection ratio, and a second extent or region 368.4 has a fourth density and a fourth compression/deflection ratio. The fourth density and fourth compression/deflection ratio are greater than the third density and third compression/deflection ratio. The first extent or region 368.2 may be positioned adjacent to the panel, frame, or housing and is surrounded or partially surrounded by the second extent or region 368.4. The deformable members 365, 405 and elbow energy attenuation member 368 provide a substantial advantage over conventional robot elbows that lack these features.

### 1. Elbow Dissipating Assembly

As best shown in FIGS. 2-6, the elbow dissipating assembly 354.2 of the robot 1 includes an elbow energy attenuation member 368, which is coupled to the lower humerus 36 and is positioned in a front or internal region 391 of the lower humerus 36 adjacent to the elbow joint (J4) 374. As described above, the front region 391 of the lower humerus housing 362 includes an internal elbow cover 366 that is removably coupled to the frame 364 of the lower humerus housing 362. The elbow energy attenuation member 368 can be coupled to the exterior surface 366.4 of the cover 366 via a member coupling means, which may include one or more fasteners-namely threaded fasteners, adhesives, any other bonding methods or systems, an over-molding process, any combination thereof, any other coupler disclosed herein, or any other similar method of coupling said member 368 to the housing 362. As such, the elbow energy attenuation member 368 is only coupled to the lower humerus 36 and is not coupled to the upper forearm 40 or any other assemblies contained within robot 1 and does not extend across multiple degrees of freedom.

The elbow energy attenuation member 368 may be made of energy-attenuating materials that are of different densities. For example, the elbow energy attenuation member 368 may be made from an energy attenuating material of two different densities. As shown in FIG. 2, the member 368 may comprise distinct extents or regions structurally, such as an outer rim 368.2 and an inner mesh 368.4. The rim 368.2 and mesh 368.4 can be made from the same energy-absorbing material or different ones. Furthermore, even if using the same material, the rim and mesh could be fabricated with different densities, potentially resulting in varying compression/deflection ratios within the elbow energy attenuation member 368.

### 2. Elbow Protective Assembly

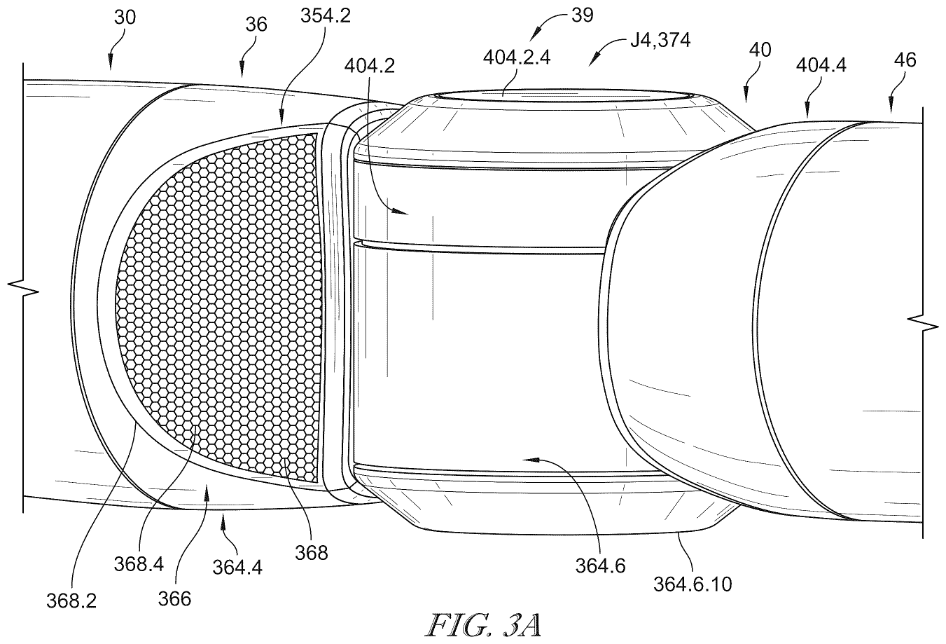

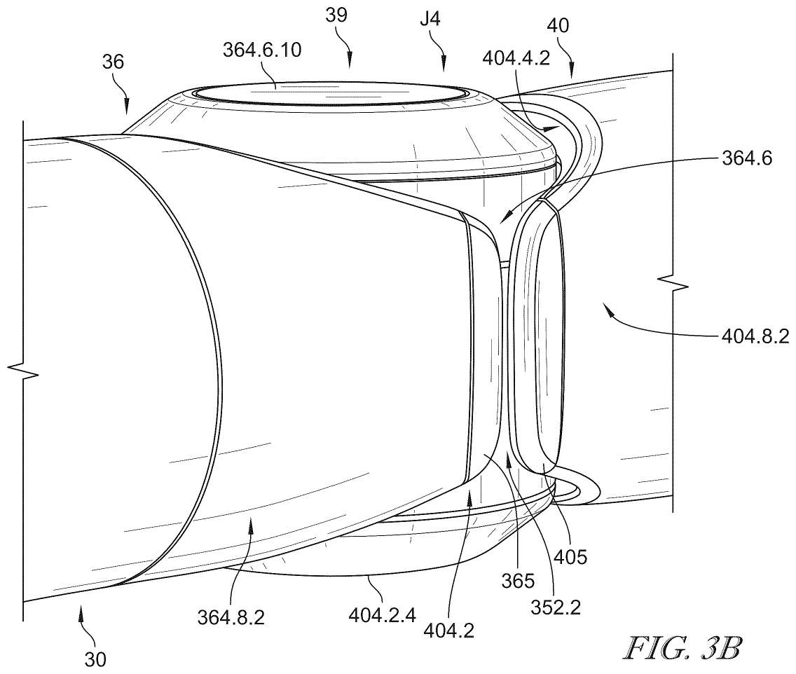

Referring to FIGS. 3-5, the elbow protective assembly 352.2 includes a deformable member 365 coupled to the rear portion 364.8.2 of the lower humerus 36 and a deformable member 405 coupled to the rear portion 404.8.2 of the upper forearm 40. The lower humerus housing 362 includes an end stop mount 364.8 for coupling a replaceable upper deformable member 365. The lower humerus housing 362 is shaped such that the rear portion 364.8.2 tapers from the lower humerus coupling assembly 364.2 to a member mounting surface 364.8.4 positioned at an extent of the elbow actuator receiving assembly 364.6. The member mounting surface 364.8.4 is configured to receive the replaceable upper deformable member 365 that is fastened to the member mounting surface 364.8.4. The member mounting surface 364.8.4 may also have an end stop projection 364.8.8 extending from the surface that is configured to mate with the replaceable upper deformable member 365. The end stop projection 364.8.8 may be made of the same or a different material as the housing 362.

Similarly, as shown in FIG. 3, the upper forearm housing 402 includes an end stop mount 404.8 that faces the end stop mount 364.8 of the lower humerus 36. The upper forearm housing 402 is shaped such that the rear portion 404.8 tapers from the lower forearm coupling assembly 404.6 to a member mounting surface 404.8.4 positioned along an extent of the upper forearm coupling assembly 404.2. The member mounting surface 404.8.4 is configured to receive a replaceable lower deformable member 405 that is fastened to the member mounting surface 404.8.4. The member mounting surface 404.8.4 may also have an end stop projection 404.8.8 extending from the surface that is configured to mate with the replaceable lower deformable member 405. The end stop projection 404.8.8 may be made of the same or a different material as the housing 402.

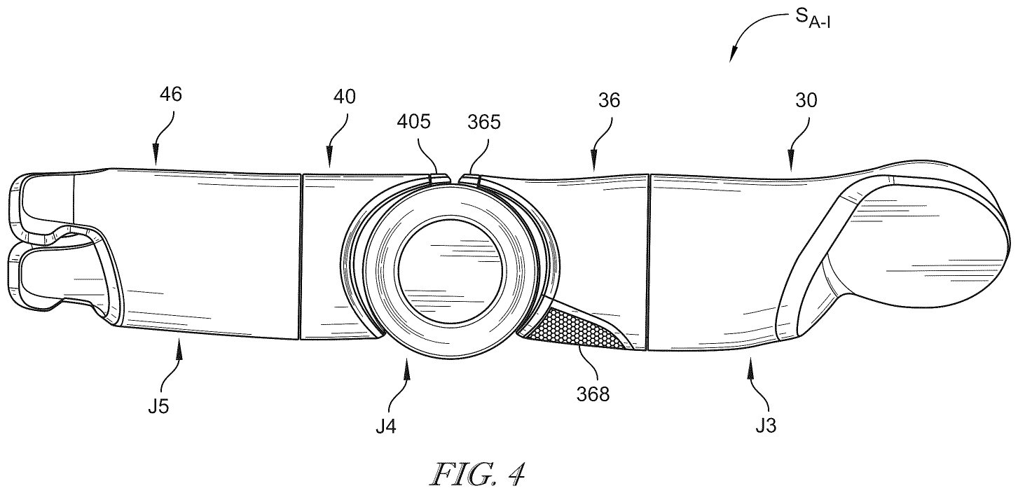

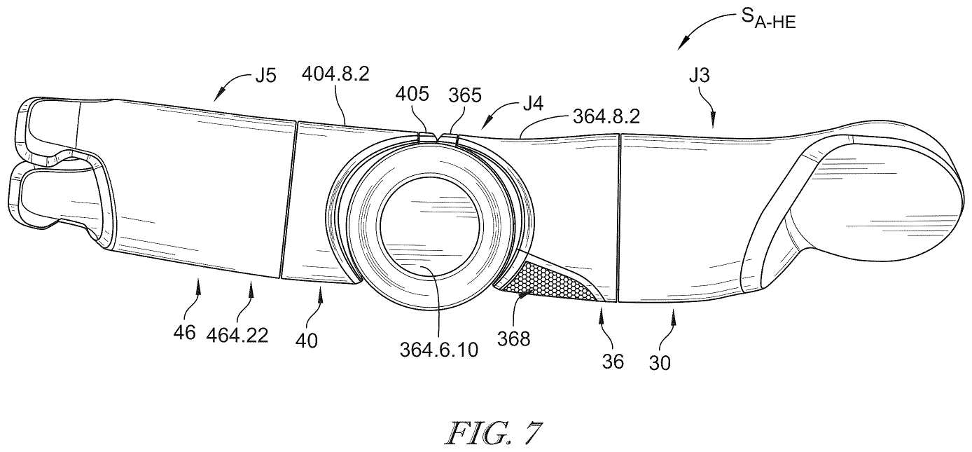

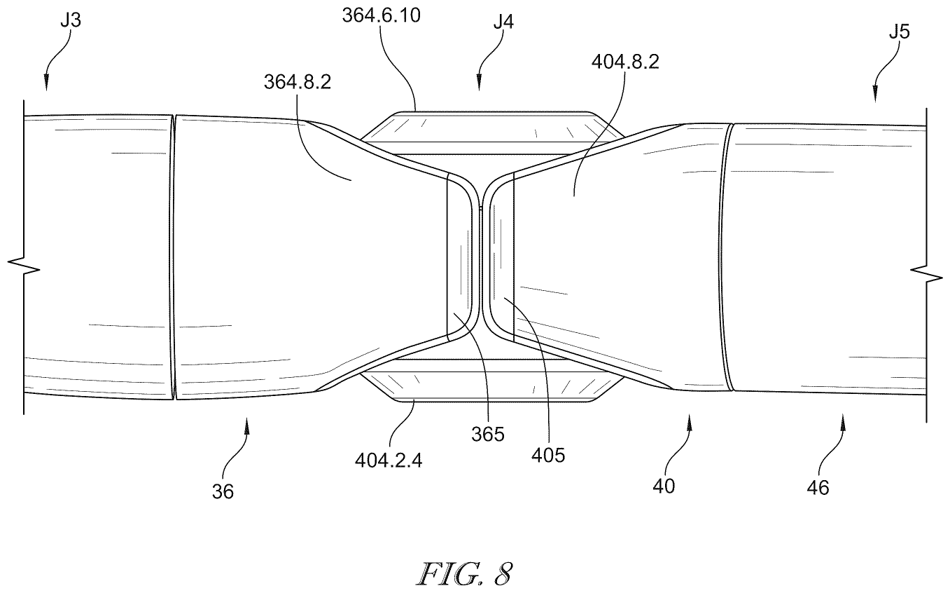

The external end stop mounts 364.8, 404.8 are formed such that the member mounting surfaces 364.8.4, 404.8.4, and attached replaceable deformable members 365,405, are substantially parallel to the axis of rotation of the elbow actuator (J4) 374. Replaceable lower deformable members 365, 405 are spaced apart when the arm is in an initial position S_{A-I}, without flexing or extending the arm about the elbow (FIG. 4). The end stop mounts 364.8, 404.8 and attached replaceable lower deformable members 365, 405 are configured such that when the elbow is hyperextended, the replaceable lower deformable members 365, 405 impact each other, which limits further movement (FIGS. 7-8). The deformable members 365, 405 may be made from any material, preferably a deformable one, which includes plastics or polymers, and the energy absorbing materials listed below with respect to the energy attenuation member 368.

### 3. Elbow Kinematics

FIGS. 4-8 generally relate to the range of motion and associated kinematics of the arm 5 about the elbow of the robot 1. The elbow actuator (J4) 374 is configured to bend in a manner that substantially mimics the movements of a human. In particular, the elbow assembly 39 including the lower humerus 36 and upper forearm 40 are coupled about the elbow actuator (J4) 374. The lower forearm 46, wrist 50, and hand 56 extend from the upper forearm 40 and pivot with respect to the lower humerus 36. The disclosed arm includes a range of motion greater than 80 degrees, preferably greater than 120 degrees, and most preferably between 140 degrees and 160 degrees. This range of motion allows the arm assembly to be placed in flexion between 1-140 degrees and hyperflexion between 1 and 20 degrees.

In FIG. 1B, the robot 1 is shown with the arm 5 in an extended position, where the arms are fully extended at the sides of the robot 1 and the palms of the hands 56 are facing forward. This position is also considered an initial position S_{A-I} of the arm 5 for the purpose of describing the movement about the elbow of the robot 1, where the rotational axes A₃, As of the arm twist actuator (J3) and the lower arm twist actuator (J5) are aligned and define the arm axis A_{A}. In this position, the elbow actuator (J4) 374 is positioned such that its rotational axis A₄ is perpendicular to the ground or support surface of the robot 1 and parallel to the sagittal and coronal planes. The arms 5 are oriented such that the inner region 391 of the lower humerus 36, including the energy attenuation member 368, and the inner region of the upper forearm 40 are forward facing, and the rear deformable members 365, 405 (FIG. 3B) are facing rearward.

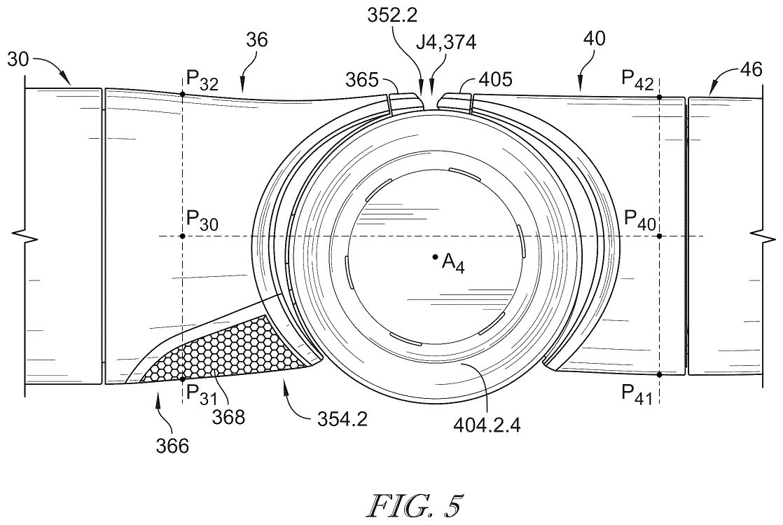

Referring to FIG. 5, a top view of the elbow 39 is shown in the initial position S_{A-I}. In this example, when the elbow actuator (J4) 374 rotates (clockwise) to move the upper forearm 40 toward the lower humerus 36, the elbow 39 is in a flexion position or a flexed state. On the contrary, when the lower forearm 40 rotates in the opposite direction (counter-clockwise) a short distance about the rotational axis A₄ before the rear deformable members 365, 405 contact each other, the elbow is in a hyperextended state. For example, the elbow's range of motion may range from about −1 to −162 degrees (flexed), to normal at 0 degrees, and to about 1 to 18 degrees (hyperextended).

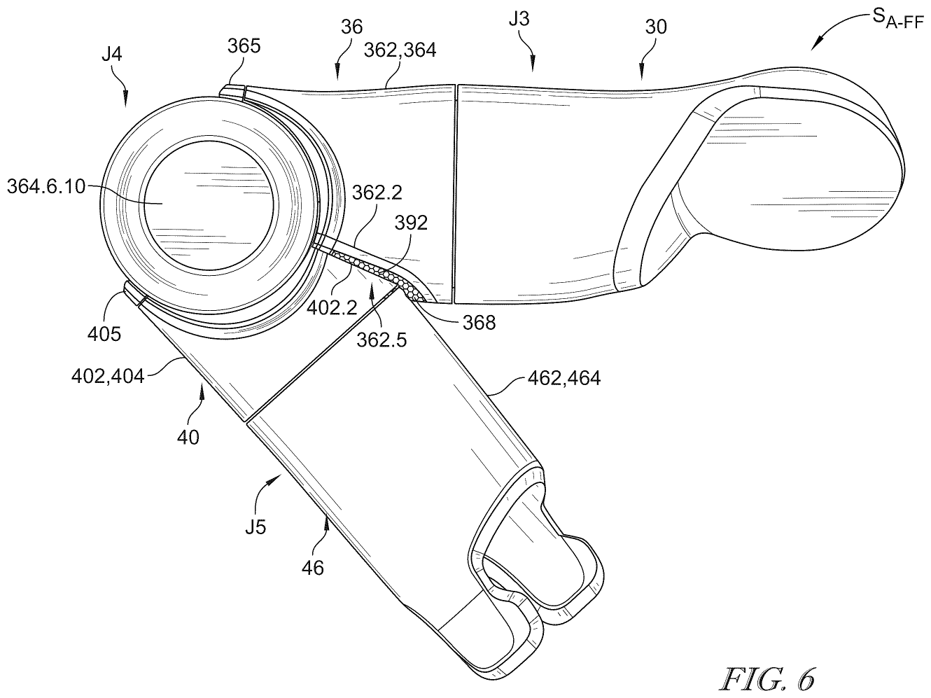

In FIG. 4, the arm assembly 5 of the robot 1 is shown in an initial position S_{A-I}. The arm 5 is considered in a flexed state as the elbow actuator (J4) 374 bends the forearm 40 inward toward the lower humerus 36 and may contact the energy attenuation member 368. When the upper forearm 40 contacts the energy attenuation member 368 of the lower humerus 36, the arm 5 may continue to bend at the elbow until a first range of motion limit, where the arm 5 is considered in a fully flexed position S_{A-FF}, as shown in FIG. 6. The energy attenuation member 368 temporarily deforms with compression and may return to its previous form when the lower humerus 36 and upper forearm 40 are no longer in contact. In this example, compression of the energy attenuation member 368 begins at about 80 degrees and continues until the range of motion limit, at about 135 degrees. Conversely, FIGS. 7-8 show the arm assembly in a hyperextended position S_{A-HE}, where the forearm is moved in the opposite direction until the range of motion limit, when the deformable members 365, 405 impact each other, at about at least 5 degrees, preferably at least 10 degrees, and most preferably at least 15 degrees. In other words, the total range of motion can be about 180 degrees, preferably 165 degrees, and most preferably between 140 degrees and 160 degrees.

The inclusion of the elbow energy attenuation member 368 may facilitate a smoother range of motion and a more natural, human-like appearance for the robot 1. When the arm 5 is bent or flexed, the energy attenuation member 368 is compressed to limit the movement of the upper forearm 40 toward the lower humerus 36 by gradually applying additional resistive pressure (Pr) as the upper forearm 40 continues to move towards the lower humerus 36. In light of the application of the additional resistive pressure (Pr), an opposed compressive pressure (Pc) will be applied by the second assembly, or the housing 402 of the upper forearm 40, on the energy attenuation member 368. Like the resistive pressure Pr, the compressive pressure (Pc) will increase as the second assembly, or the housing 402 of the upper forearm 40, further compresses or moves from a partially flexed to a fully flexed position S_{A-FF}. However, a sensor contained within the robot 1 will not allow the compressive pressure Pc to exceed a predetermined pressure value on an external object that is positioned between the second assembly, or the housing 402 of the upper forearm 40, and the energy attenuation member 368. In other words, the robot 1 will stop moving the second assembly, or the housing of the upper forearm 40, towards the energy attenuation member 368 if and when the compressive pressure Pc exceeds the predetermined pressure value on an external object. The predetermined pressure value may be any value between 25 N/cm² to 800 N/cm², preferably between 100 N/cm² to 400 N/cm², and most preferably between 150 N/cm² to 350 N/cm². For example, said predetermined pressure value may be 110 N/cm², 170 N/cm², 200 N/cm², 220 N/cm², or 300 N/cm².

It should be understood that the compressive pressure Pc will also result in a compressive force Fc that is also applied to the external object. Thus, it should also be understood that a sensor contained within the robot 1 will not allow the compressive force Fc to exceed a predetermined force value on an external object that is positioned between the second assembly, or the housing 402 of the upper forearm 40, and the energy attenuation member 368. In other words, the robot 1 will stop moving the second assembly, or the housing of the upper forearm 40, towards the energy attenuation member 368 if and when the compressive force Fc exceeds the predetermined force value on an external object. The predetermined force may be any value between 25 N to 500 N, preferably between 50 N to 250 N, and most preferably between 130 N to 210 N. For example, said predetermined force value may be 65 N, 130 N, 140 N, 180 N, or 220 N.

For example, if a human finger (e.g., having an average diameter of 16-20 mm) were placed between the second assembly, or the housing 402 of the upper forearm 40, and the energy attenuation member 368, the robot 1 may continue moving the second assembly, or the housing 402 of the upper forearm 40, towards the energy attenuation member 368 and about the rotational axis until the compressive pressure that is exerted between the second assembly, or the housing of the upper forearm 40, and the energy attenuation member 368 reaches 250 N/cm² on the human finger. Once a compressive pressure that exceeds 250 N/cm² is applied to said human finger, the robot 1 will stop or be unable to move the second assembly, or the housing 402 of the upper forearm 40, further towards the energy attenuation member 368 and about the rotational axis. In another example, if a human arm (e.g., having an average diameter of 9-11 cm) were placed between the second assembly, or the housing 402 of the upper forearm 40, and the first assembly, or the housing of the lower humerus 36, the robot 1 may continue moving the second assembly, or the housing 402 of the upper forearm 40, towards the first assembly, or the housing of the lower humerus 36, and about the elbow axis until the compressive pressure that is exerted between the second assembly, or the housing 402 of the upper forearm 40, and the first assembly, or the housing of the lower humerus 36, reaches 180 N/cm² on the human arm. Once a compressive pressure that exceeds 180 N/cm² is applied to said human arm, the robot 1 will stop or be unable to move the second assembly, or the housing 402 of the upper forearm 40, further towards the first assembly, or the housing of the lower humerus 36, and about the elbow axis.

Likewise, if a human finger (e.g., having an average diameter of 16-20 mm) were placed between the second assembly, or the housing 402 of the upper forearm 40, and the energy attenuation member 368, the robot 1 may continue moving the second assembly, or the housing 402 of the upper forearm 40, towards the energy attenuation member 368 and about the rotational axis until the compressive force that is exerted between the second assembly, or the housing 402 of the upper forearm 40, and the energy attenuation member 368 reaches 140 N on the human finger. Once a compressive force that exceeds 140 N is applied to said human finger, the robot 1 will stop or be unable to move the second assembly, or the housing 402 of the upper forearm 40, further towards the energy attenuation member 368 and about the rotational axis. In another example, if a human arm (e.g., having an average diameter of 9-11 cm) were placed between the second assembly, or the housing 402 of the upper forearm 40, and the first assembly, or the housing of the lower humerus 36, the robot 1 may continue moving the second assembly, or the housing 402 of the upper forearm 40, towards the first assembly, or the housing of the lower humerus 36, and about the elbow axis until the compressive force exerted between the second assembly, or the housing 402 of the upper forearm 40, and the first assembly, or the housing of the lower humerus 36, reaches 160 N on the human arm. Once a compressive force that exceeds 160 N is applied to said human arm, the robot 1 will stop or be unable to move the second assembly, or the housing 402 of the upper forearm 40, further toward the first assembly, or the housing of the lower humerus 36, and about the elbow axis.

It should also be understood that the robot 1 is designed to ensure that the compressive force or compressive pressure shall never apply a flexed pressure or flexed force on an external object. It should be understood that this flexed pressure or flexed force is regardless of any measurement system (e.g., torque cell, pressure sensor, or force sensor) that is included within the robot 1. In other words, said robot 1 can only apply a flexed pressure or flexed force that is less than a predetermined flexed pressure or predetermined flexed force in the fully flexed position S_{A-FF}. Said predetermined flexed pressure may be any value between 25 N/cm² to 800 N/cm², preferably between 100 N/cm² to 400 N/cm², and most preferably between 150 N/cm² to 350 N/cm² and the predetermined flexed force may be any value between 25 N to 500 N, preferably between 50 N to 250 N, and most preferably between 130 N to 210 N. For example, when the elbow joint is in the fully flexed position S_{A-FF}, a force that is less than 140 N is applied to an object that is positioned between an extent of the energy attenuation member 368 and an extent of one of the first or second housings 362, 402.

The above described compressive force or compressive pressure may be measured using any known method, including using: (i) the torque cells contained within the actuators, or (ii) an external pressure or force sensor. Said external pressure or force sensor may be embedded into any housing or the energy attenuation member 368, and wherein said pressure or force sensor may be or may utilize a load cell, strain gauge, 6-axis force/torque sensor, joint torque sensor, force sensing resistor (FSR), piezoresistive sensor, capacitive sensor, piezoelectric sensor, MEMS force/pressure sensor, tactile sensor array, camera-based tactile sensor, optical force sensor (general category, including intensity/phase modulation), Fiber Bragg grating (FBG) sensor, optical force nanosensor, hall effect force sensor, magnetoclastic sensor, ultrasonic force/pressure sensor, hydraulic/pneumatic pressure sensor, conductive fabric/textile sensor, quantum tunneling composite (QTC) sensor, electromechanical film (EMFi) sensor, resonant pressure sensor, electromagnetic sensor, inductive force sensor, carbon nanotube-based sensor, graphene-based pressure sensor, elastomeric pressure sensor, liquid metal sensor, triboelectric sensor, magnetic elastomer sensor, nanoindentation sensor, electroactive polymer (EAP) sensor, eddy current sensor, capacitive micromachined ultrasonic transducer (CMUT) sensor, surface acoustic wave (SAW) sensor, air-gap capacitive sensor, magnetostrictive sensor, microfluidic force sensor, thermal-based pressure sensor, optofluidic sensor, nanoparticle-based pressure sensor, flexible printed circuit (FPC) sensor, or a silicone rubber embedded sensor.

As shown in FIG. 6, the elbow energy attenuation member 368 will become fully compressed when the arm 5 reaches the fully flexed position S_{A-FF}. This design results in more fluid, lifelike movements and can potentially increase the usable range of motion compared to designs with harsh hard stops. In contrast, a purely rigid design might inherently have much less range of motion, or achieving a comparable range of motion could necessitate designing recesses or cut-outs in the lower humerus 36 and/or the upper forearm 40 to avoid interference, which may potentially compromise structural integrity. As such, the first assembly, or lower humerus 36, includes a first interior point P31 and a first exterior point P32, and wherein the elbow axis is substantially centered between the first interior and exterior points P31, P32. Said substantially centered means that the distance between the elbow axis A₄ and the center P30 of the first interior point P31 and the first exterior point P32 is less than 10 mm, and preferably less than 5 mm. Likewise, the second assembly, or upper forearm 40, includes a second interior point P41 and a second exterior point P42, and wherein the elbow axis is substantially centered between the second interior and exterior points P41, P42. Said offset from the center means that the offset between the elbow axis A₄ and the center P40 of the second interior point P41 and the second exterior point P42 is less than 10 mm, and preferably less than 5 mm. It should be understood that the interior points P31, P41 and exterior points P32, P42 are positioned on an outermost extent of said lower humerus 36 and/or the upper forearm 40, and as such they may be positioned exterior to the housing of said lower humerus 36 and/or the upper forearm 40. For example, said points may be positioned on the energy attenuation member 368 or a member that covers the energy attenuation member 368.

Also, as shown in FIG. 6, when the arm 5 reaches the fully flexed position, a gap 392 is formed between an outer surface 362.2 of the lower humerus housing 362 and an outer surface 402.2 of the upper forearm housing 402. Said gap 392 has a predetermined width that may be greater than 0.25 inches (or 0.635 centimeters). While said gap 392 is occupied by the energy attenuation member 368, said gap 392 is positioned between the outer surface 362.2 of the lower humerus housing 362 and an outer surface 402.2 of the upper forearm housing 402 to help ensure or eliminate a pinch point between the lower humerus housing and the upper forearm housing 402. It should be understood that the size of the gap 392 may be increased or may be eliminated in alternative embodiments.

In addition to the rotational axis being substantially centered along the arm 5, the first assembly, or lower humerus 36, lacks a recess configured to receive an extent of the elbow actuator in a fully flexed position. While a recess 362.5 is formed in the housing 362 of the first assembly, or the housing 362 of the lower humerus 36, said recess 362.5 is occupied by the energy attenuation member 368 and thus the overall first assembly, or lower humerus 36, lacks a recess. Further, the second assembly, or upper forearm 40, lacks a recess configured to receive an extent of the elbow actuator in a fully flexed position. In addition to the entire assembly lacking a recess, said housing 402 of the second assembly, or the housing 402 of the upper forearm 40, also lacks said recess. It should be understood that the above disclosure is focused on a substantial recess that is configured to receive an extent of the elbow actuator and is not focused on minor deviations in the assemblies 36, 40. As such, said lack of recesses focuses on a recess that has a depth greater than 5 mm at a location and is designed to receive an extent of the elbow actuator. Overall, the lack of an external recess enables the arm to appear more streamlined, aesthetically pleasing, and provides a human-like appearance for the elbow joint (J4) 374. Designs relying solely on rigid components might require visible recesses, offsets, or bulky external stops to manage the range of motion, which can look unnatural. Soft members, such as the member 368, can be integrated more smoothly into the joint's contours, contributing to a more organic and less mechanical look for the robot 1.

The inclusion of the elbow energy attenuation member 368 can also significantly enhance the mechanical protection of the elbow actuator (J4) 374 and reduce stress on its internal parts. By acting as a buffer, the deformable members absorb and dissipate energy when the joint reaches its end of travel. This casing of the hard stop reduces the impact forces, distributing them over a slightly longer duration and larger area. This lessens wear and tear on components like gears, bearings, and actuators, preventing damage and potentially extending the operational lifespan of the robot 1.

### F. Knee Assembly

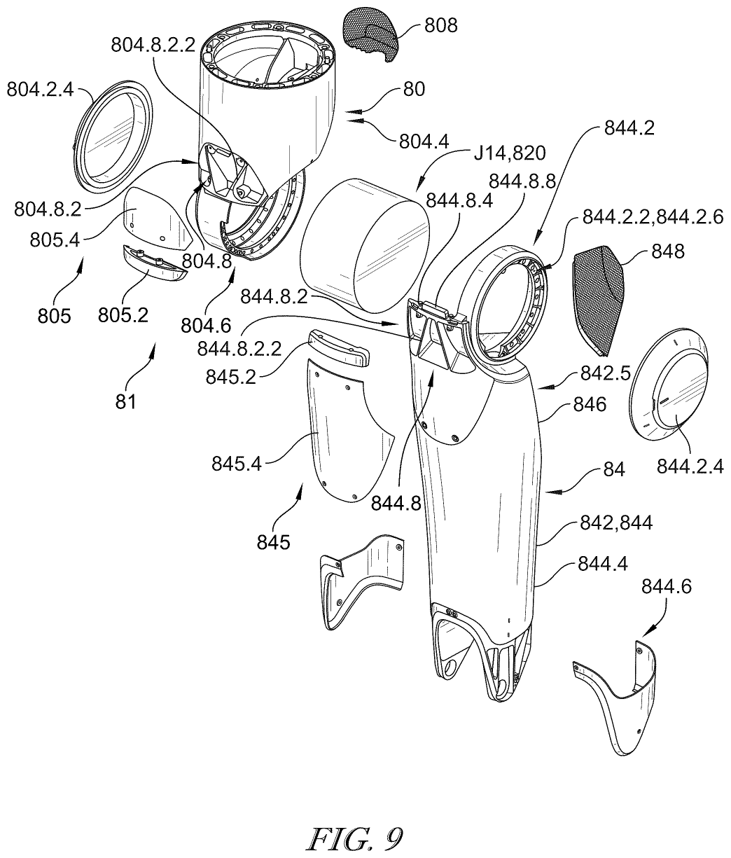

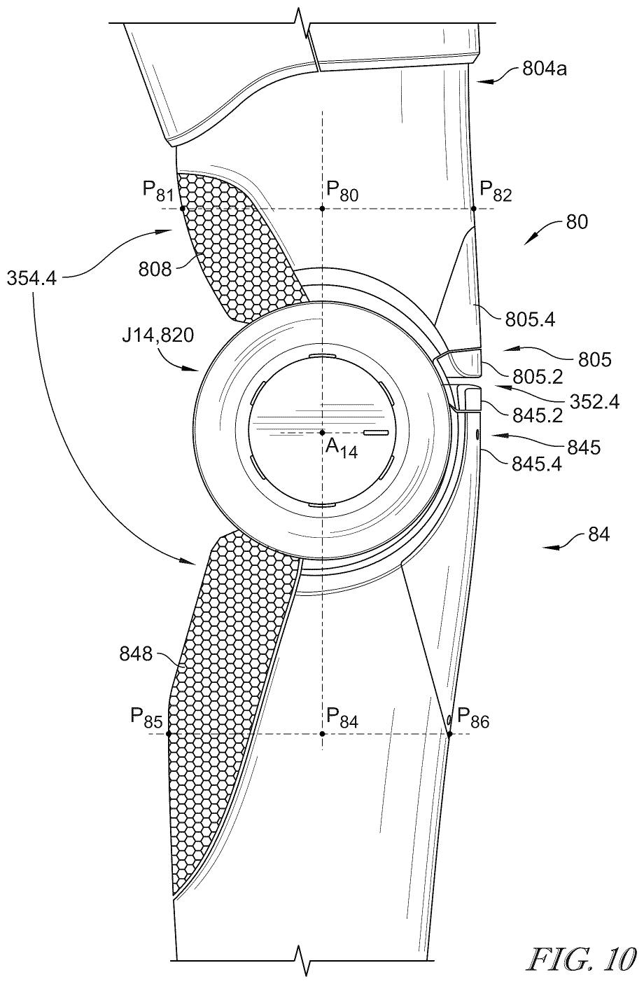

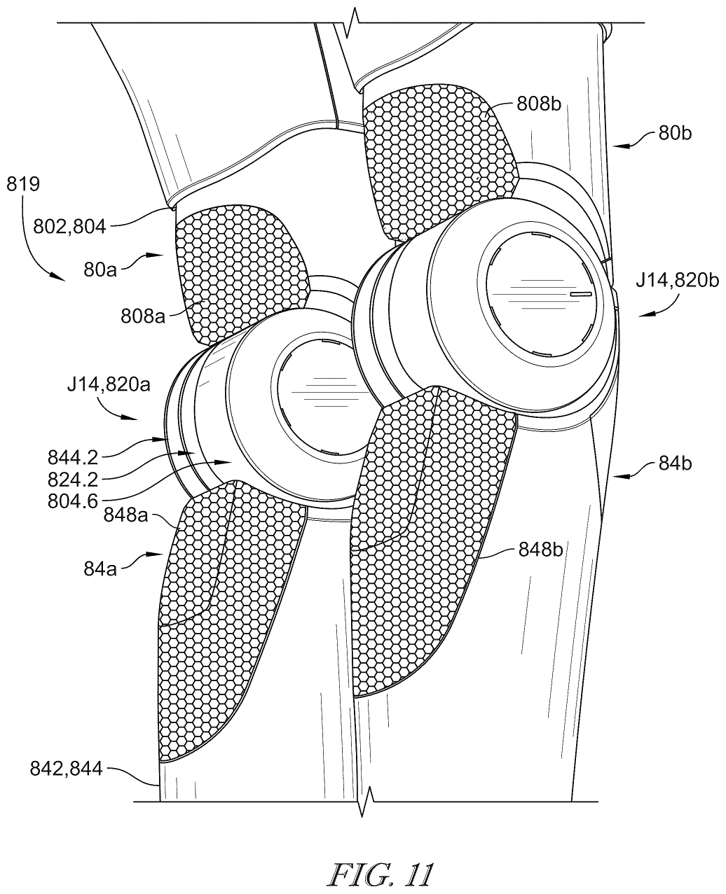

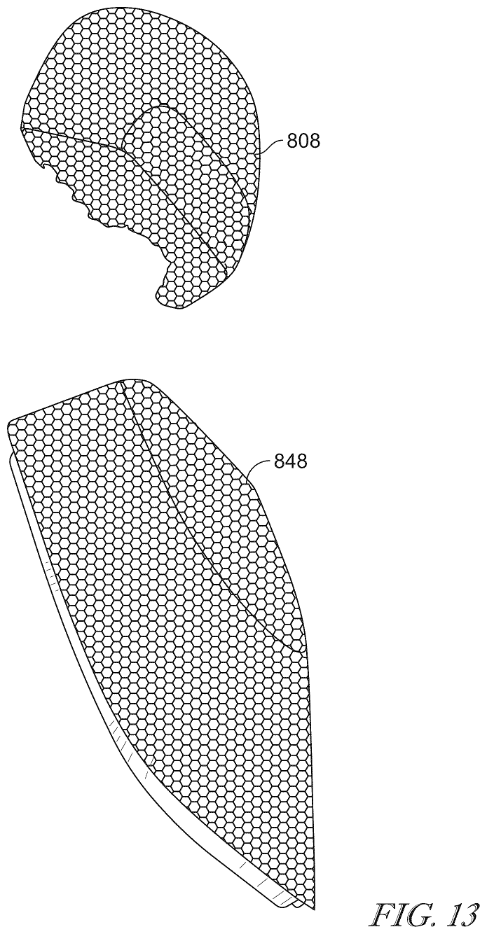

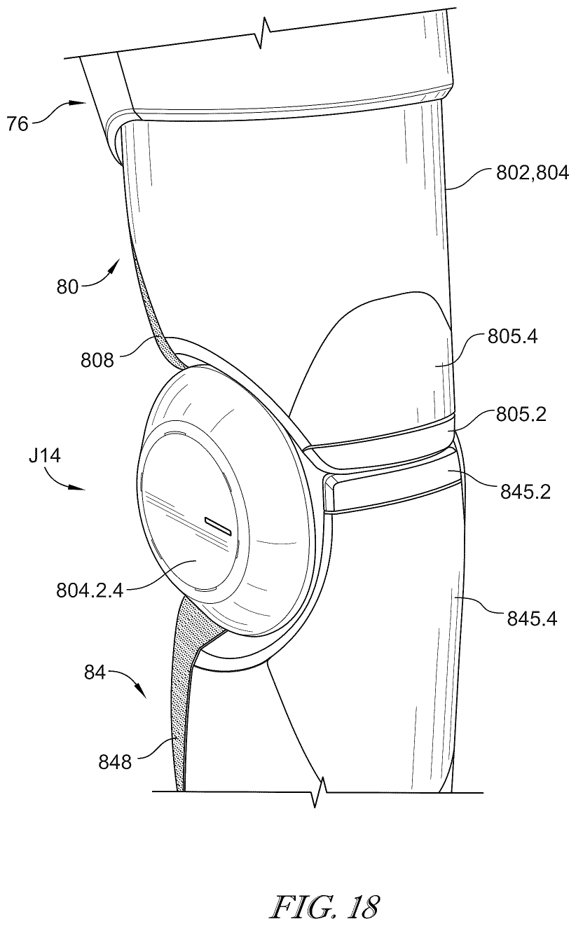

FIGS. 9-19 show the knee assembly 81 of the leg, which includes the lower thigh 80, the shin 84, and the knee actuator (J14) 820 coupling the lower thigh 80 and shin 84. The lower thigh 80 is coupled to the upper thigh 76 via the leg twist actuator (J13) 782, which controls the rotational movement of the leg and foot about a leg axis A_{L} that is colinear with the axis A₁₃ of rotation of the leg twist actuator (J13) 782 and the coronal plane P_{C} when the robot 1 is in the neutral position. In particular, the overall position of the knee actuator (J14) 820 relative to the robot's torso 16 is controlled by the hip flex actuator (J11) 720, the hip pivot actuator (J12) 768, and the leg twist actuator (J13) 782, which are coupled to the pelvis 64 and upper thigh 76.

### G. Lower Thigh Assembly

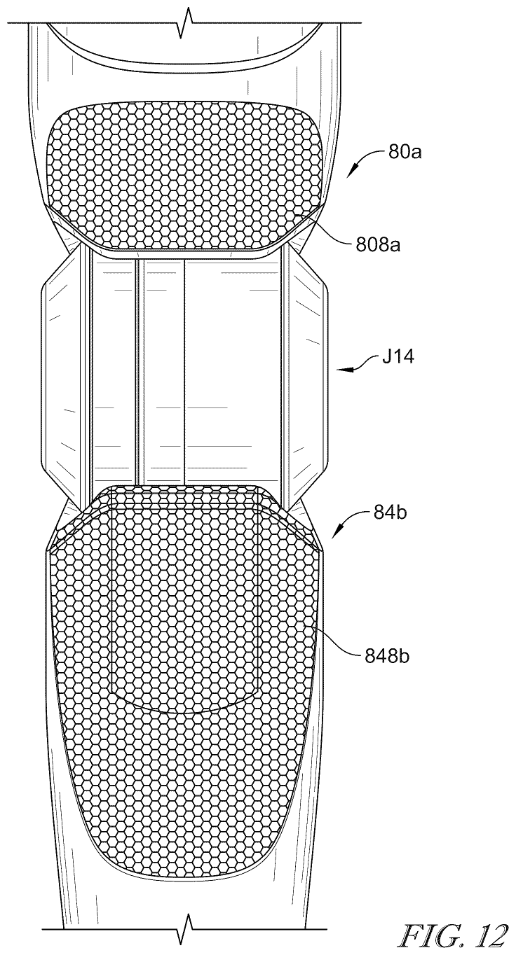

As shown in FIGS. 12-19 and 22-29, the lower thigh assembly 80 includes a housing 802, the knee actuator assembly (J14) 820, and a cooling device 836 (e.g., a ventilation device, a fan, a blower, etc.). The housing 802 includes: a frame 804, an upper knee guard 805 coupled to a frontal portion of the frame 804, and an energy attenuation member 808 coupled to a rear portion of the frame 804. The frame 804 includes a coupling assembly 804.2 that is designed to be coupled to the output adapter 790 of the leg twist actuator (J13) 782, an extender portion 804.4 positioned between the coupling assembly 804.2 and an actuator receiving assembly 804.6, the actuator receiving assembly 804.6 that is configured to receive an extent of the knee actuator (J14) 820, and an end stop mount 804.8 that is configured to couple with a deformable member 805.2 that is an extent of the knee protective assembly 352.4. A cooling device 836 may be contained within the open space or interior volume V_{LT} of the extender portion 804.4.

In particular, the frame 804 is shaped with a tapered exterior profile from the coupling assembly 804.2 at the proximal end 804.4a through the extender portion 804.4, where the frame 804 has a coupling wall portion 804.2.6 at the proximal end 804.4a that is substantially similar in size to the leg twist actuator (J13) 782 or the output adapter 790 of the leg twist actuator (J13) 782. In particular, a coupling end face 804.2.6.10 of the coupling wall portion 804.2.6 of the lower thigh 80 is configured to couple with the output adapter 790 of the leg twist actuator (J13) 782 housed within the upper thigh 76. Additionally, the upper thigh housing 762 may be configured with a distal end portion 762a that surrounds the leg twist actuator (J13) 782, and where the coupling assembly 804.2 at the proximal end 804.4a of the lower thigh 80 is configured to be received therein to couple with the leg twist actuator (J13) 782. The leg twist actuator (J13) 782 is configured to rotate or move the lower thigh 80 and coupled lower leg assembly 6.2 about the leg twist axis A₁₃, wherein said leg twist axis A₁₃ is colinear with the coronal plane P_{C}.

The lower thigh actuator receiving assembly 804.6 is configured to be coupled to the actuator housing 824.2 of the knee actuator assembly (J14) 820. The actuator receiving assembly 804.6 includes an actuator receptacle 804.6.2 and an actuator mount 804.6.4. A substantial portion of the knee actuator (J14) 820 is received into the actuator receptacle 804.6.2, and the knee actuator housing 824.2 is coupled to the actuator mount 804.6.4. The lower thigh actuator receiving assembly 804.6 is configured such that it is off-center, and when coupled to the knee actuator (J14) 820, the knee actuator housing 824.2 is substantially centered beneath the extender portion 804.4, and the knee coupling assembly 844.2 of the shin housing 842 encloses the knee actuator (J14) 820 on the opposite side.

An external extent of the lower thigh housing 802 includes an end stop mount 804.8. The end stop mount 804.8 includes an external mount portion 804.8.2 and a deformable surface 804.8.4. The lower thigh housing 802 is shaped such that an external surface portion 804.8.2 tapers from the lower thigh coupling assembly 804.2 to the deformable surface 804.8.4 positioned at an external extent of the actuator receiving assembly 804.6. The external mount portion 804.8.2 is configured to couple with a replaceable guard plate 805.4 and may include ribs 804.8.2.2 for additional structural support. The deformable surface 804.8.4 is configured to receive an upper deformable member 805.2 that is fastened to the deformable surface 804.8.4. The deformable surface 804.8.4 may also have an end stop projection 804.8.8 extending from the surface that is configured to mate with the deformable member 805.2. The end stop projection 804.8.8 may be made of the same or a different material as the housing 802.

### H. Shin Assembly

Referring to FIGS. 1, 5, 12-19, and 22-29, the proximal end of the shin 84 is coupled to the lower thigh 80 at the knee actuator (J14) 820. The shin assembly 840 includes: (i) a housing 842 and the foot flex actuator assembly (J15) 860. In the illustrative embodiment, the shin 84 is the only part of the robot 1 that includes a linear actuator. In other words, all other actuators contained in the robot 1 are rotary actuators. In an alternative embodiment, the linear actuator in the shin may be replaced by a rotary actuator that can be coupled with the talus in a similar manner.

As best shown in FIG. 5, the shin housing 842 includes: (i) a shin frame 844, (ii) a lower knee guard 845, (iii) a rear access panel 846, and (iv) a rear energy attenuation member 848. The shin frame 844 of the housing 842 includes: (i) a knee coupling assembly 844.2, (ii) a shin body 844.4, (iii) a foot coupling assembly 844.6, and (iv) an end stop mount 844.8 configured to couple with the lower knee guard 845.

The knee coupling assembly 844.2 of the shin housing 842 is configured to be coupled to the output of the knee actuator assembly (J14) 820. To enable the coupling of the knee coupling assembly 844.2 to the knee actuator assembly (J14) 820, said knee coupling assembly 844.2 includes a cover opening 844.2.6 suitable to provide access to the input mount 844.2.2 to secure fasteners to couple it to the output of the knee actuator (J14) 820. The actuator cover 844.2.4 of the shin 840 may be removably attached to the cover opening 844.2.6 to enclose the knee actuator assembly (J14) 820 and wiring connections. The actuator cover 844.2.4 and the cover opening 844.2.6 may be threaded or have other means of removable closure to access wiring connections. A combination of the knee coupling assembly 844.2 of the shin and an extent of the housing of the lower thigh enables the knee actuator (J14) 820 to be fully encased by said combination.

As shown in FIG. 12, the illustrative shin body 844.4 has an elongated shape with a hollow interior that extends from the knee coupling assembly 844.2 to the foot coupling assembly 844.6. The hollow interior is defined by walls with varying thicknesses and structural features designed to support the robot 1 and house the foot flex actuator assembly (J15) 860. A distal end of a connecting rod 872 of the foot flex actuator assembly (J15) 860 is coupled to the talus 88 and configured to change the pitch of the foot 92.

The foot coupling assembly 844.6 is configured to couple the shin 84 to the talus 88, which is coupled to the foot 92. The foot coupling assembly 844.6 may include (i) mounting apertures 844.4.6.6 formed in the distal tapered end 844.4.6 of the shin body 844.4, (ii) a mounting pin 844.6.6, and (iii) ankle side covers 844.6.2. The tapered end 844.4.6 having an opening 844.4.8 through which an actuator connecting rod 872 may extend to also couple with the talus 880. The shin body 844.4 having a curvilinear shape around the perimeter of the opening 844.4.8 such that opposing side portions include the mounting apertures 844.4.6.6. The mounting pin 844.6.6 is configured to span the tapered end 844.4.6 through the mounting apertures 844.4.6.6 and coupled the shin body 844 to the talus.

Further, external extent of the shin housing 842 includes an end stop mount 844.8 including an external mount portion 844.8.2 and a deformable member mounting surface 844.8.4. The shin housing 842 is shaped such that an external surface portion 844.8 tapers from the shin body 844.4 to the deformable member mounting surface 844.8.4 positioned along an extent of the knee coupling assembly 844.2. The external mount portion 844.8.2 is positioned forward of an extent of the knee coupling assembly 844.2 and may include ribs 844.8.2.2 for additional structural support at the knee actuator (J14) 820 and behind the guard plate 845. The external mount portion 844.8.2 may be configured to couple with a replaceable guard plate 845.4. The deformable member mounting surface 844.8.4 is configured to receive a lower deformable member 845.2 that is fastened to the deformable member mounting surface 844.8.4. The deformable member mounting surface 844.8.4 may also have an end stop projection 844.8.8 extending from the surface that is configured to mate with the lower deformable member 845.2. The end stop projection 844.8.8 may be made of the same or a different material as the housing 842.

### I. Knee Actuator

As shown in FIGS. 1A-1B and 9-19, the knee actuator (J14) 820 is coupled between the lower thigh 80 and the shin 84 on each of the left and right sides to affect the bend of the leg. Each of the left and right knee actuator assemblies (J14) 820 may include any component, part, or function described above in connection with the elbow actuator, and as such, said disclosure is not repeated herein. The knee actuator assembly (J14) 820 is configured to be coupled to the frame 804 of the lower thigh 80 within the actuator receiving assembly 804.6. The shin housing 842 includes a coupling assembly 844.2 that engages the output of the knee actuator (J14) 820.

As such, the knee actuator assembly (J14) 820 is enclosed by (i) the lower thigh actuator receiving assembly 804.6 and actuator cover 804.2.4 on one side, (ii) the knee actuator housing 824.2 substantially centered beneath the external mount portion 844.8.2, and (iii) the shin coupling assembly 844.2 and actuator cover 844.2.4 on the opposite side. In particular, the lower thigh actuator receiving assembly 804.6 is configured to be coupled to the knee actuator housing 824.2 of the knee actuator assembly (J14) 820. The actuator receiving assembly 804.6 includes an actuator receptacle 804.6.2 and an actuator mount 804.6.4. A substantial portion of the knee actuator (J14) 820 is received into the actuator receptacle 804.6.2 and coupled to the actuator mount 804.6.4. An actuator cover 804.2.4 of the lower thigh 80 may be removably attached to the cover opening 804.2.6 to enclose the knee actuator assembly (J14) 820 on one side. The knee actuator housing 824.2 coupled to the actuator mount 804.6.4 is substantially centered beneath the extender portion 804.4. The shin coupling assembly 844.2 is coupled to the output adapter 828 on the opposite side of the knee actuator assembly (J14) 820. Each of the actuator covers 804.2.4, 844.2.4 includes substantially flat surfaces that are positioned a distance away from one another on opposing sides of the knee actuator (J14) 820, where the distance is less than the diameter of the lower thigh 80.

The shin coupling assembly 844.2 may include a shin input mount 844.2.2 configured to cooperate with the lower thigh output adapter 828 and accessible via an opening 844.2.6 covered by a removable cover 844.2.4. Together, the actuator receiving assembly 804.6 of the lower thigh housing 802 and the coupling assembly 844.2 of the shin housing 844 enclose the knee actuator (J14) 820. Thus, the actuator 824 is fully enclosed by (i) the knee actuator housing 824.2, (ii) an extent of the lower thigh housing 802, and (iii) an extent of the shin housing 842.

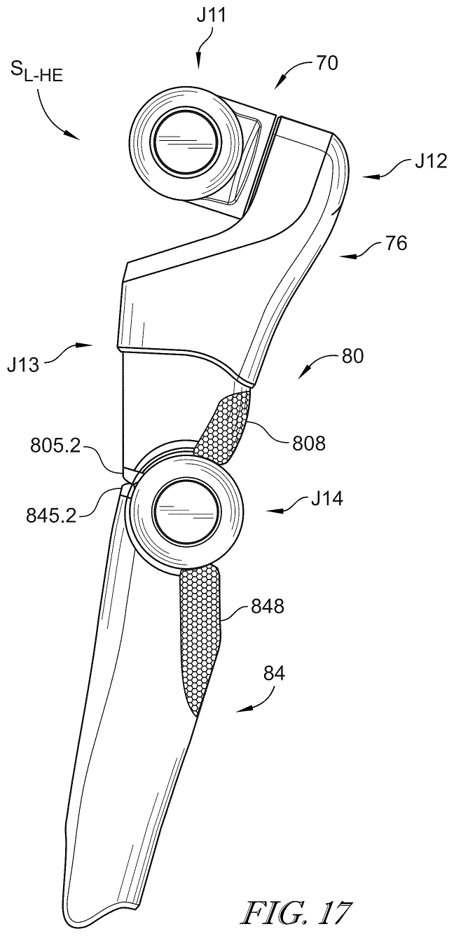

In various embodiments, the knee actuator assembly (J14) 820 may also include a heat sink integrally formed in the knee actuator housing 824.2. Said integrally formed heat sink may be made from the same material as the knee actuator housing 824.2 or from a different material. For example, both the housing 824.2 and the heat sink may be made from aluminum, or the housing 824.2 may be made from aluminum and the heat sink may be made from an aluminum-copper hybrid. The knee actuator housing 824.2 can be a passive heat exchanger that transfers the heat generated by the actuator motor 824.10 to be cooled by the cooling device 836 housed within the leg 6. As shown in FIG. 17, at least a portion of the knee actuator housing 824.2 may include the heat sink that circumscribes the housing 824.2, and wherein the heat sink has a varying thickness, forming a varied profile circumscribing the exterior surface of the knee actuator housing 824.2 of the knee actuator (J14) 820. For example, the exterior surface may be shaped with projections, fins, ridges, grooves, channels, flutes, etc., to provide an increased surface area for heat transfer, where airflow from the cooling device helps dissipate the heat from the surface, cooling the overall region.

It should be understood that the projections, ridges, grooves, channels, or flutes may be formed by structures that are integrally formed with the heat sink or structures that are coupled (e.g., welded, brazed, or thermally coupled) to said heat sink. By Coupling said structures to the heat sink and/or to the housing 824.2, the housing 824.2, heat sink, and structures may be made from different materials or made using different manufacturing methods. This may be beneficial when the housing is made using a casting method, the heat sink is made using a milling method, and the cooling structures are made using an extrusion, skiving, or stamping process and attached to the heat sink using a bonding or brazing method. Further, it should be understood that the cooling structures may be directly coupled to the exterior of the housing 824.2 or integrally formed therewith. In this embodiment, the heat sink may be omitted, and instead the structural configuration of the actuator housing 824.2 in addition to the cooling structures may act as a heat sink. In some embodiments, a separate heat sink may be positioned within one or more portions of the leg 6. In summary, (i) the actuator housing 824.2 may act as a heat sink and may include or omit cooling structures, and (ii) the heat sink may be coupled to or integrally formed with the actuator housing 824.2, and said heat sink may include or omit cooling structures.

### J. Knee Rotation Limiting System

As shown in FIGS. 1A-1B and 9-19, the rotation limiting system 350 of the robot 1 also includes a knee protective assembly 352.4 and a knee dissipating assembly 354.4. The knee protective assembly 352.4 is positioned in a frontal region of the shin 84 and lower thigh 80 near the knee and includes a lower knee guard 845 on the shin 84 and a corresponding upper knee guard 805 on the lower thigh 80. The knee guards 805, 845 include deformable members 805.2, 845.2 that are configured to protect frontal portions of the lower thigh 80 and shin 84 in hyperextension. The knee dissipating assembly 354.4 is positioned in a rear region of the shin 84 and lower thigh 80 and includes a lower knee energy attenuation member 848 coupled to the shin 84 and an upper knee energy attenuation member 808 coupled to the thigh 80. The knee energy attenuation members 808, 848 are configured to compress when the knee is bent. The knee dissipating assembly 354.4 includes components that are made from energy-absorbing materials and is designed to: (i) help ensure that the actuator (J14) 820 does not over-rotate in either direction, (ii) reduce pinch points associated with the knee, and (iii) allow the robot 1 to have a more human-like appearance.

The disclosed knee protective assembly 352.4 and knee dissipating assembly 354.4 include disposable or sacrificial parts designed to be used for a period of time and then replaced when damaged. For example, said deformable members 805.2, 845.2 and guard plates 805.4, 845.4 are designed to protect structural members of the lower thigh and shin at the knee. Similarly, the knee energy attenuation members 808, 848 protect the lower thigh and shin frame at the knee in the rear. These disposable or sacrificial parts are located in a position likely to receive high amounts of wear and tear and are made from a material that hides scratches and is more deformable than metal. These disposable or sacrificial parts provide the disclosed shin assembly with substantial advantages over conventional shins that lack these disposable or sacrificial parts.

Support for the deformable members 805.2, 845.2 and knee energy attenuation members 808, 848 may be provided by projections or other means of mounting that are integrally formed in respective housings or panels coupled to said housings. For example, support for the upper and lower frontal deformable members may be provided by projections integrally formed with the thigh and shin frames. Support for the upper and lower rear energy attenuation members may be provided by panels designed to be coupled to the lower thigh and shin frames. It should be understood that in other embodiments, the panel could be: (i) omitted or integrally formed with an extent of the deformable member or energy attenuation member, or (ii) integrally formed with an extent of the housing or frame. In various embodiments, the knee actuator (J14) 820 may include internal hard stops that limit the range of motion of the knee. The deformable members 805.2, 845.2 and knee energy attenuation members 808, 848 may be used in connection with a hard stop or in other embodiments, said members may replace the hard stop. In further embodiments, said deformable members 805.2, 845.2 and knee energy attenuation members 808, 848 may be replaced with external or internal hard stops.

The disclosed deformable members 805.2, 845.2 and knee energy attenuation members 808, 848 can be sacrificial parts that can be replaced if broken and are designed to reduce safety concerns when the robot is interacting with humans. The frontal deformable members 805.2, 845.2 may be made from plastic and can have a first density and a first compression/deflection ratio, while the rear lower knee energy attenuation members 808, 848 may include urethane and can have a second density and a second compression/deflection ratio. The disclosed second density and second compression/deflection ratio may be less, and in certain situations may be substantially less (e.g., more than 50%), than the first density and first compression/deflection ratio. In other embodiments, the knee energy attenuation members 808, 848 may include two extents, wherein the first extent or region has a third density and a third compression/deflection ratio and the second extent or region has a fourth density and a fourth compression/deflection ratio. The third density and the third compression/deflection ratio are less than the fourth density and the fourth compression/deflection ratio. The second extent or region is positioned adjacent to the panel, shin frame, or shin housing and is surrounded by the first extent or region. The deformable members 805.2, 845.2 and knee energy attenuation members 808, 848 provide a substantial advantage over conventional robot legs that lack these features.

### 1. Knee Dissipating Assembly

As best shown in FIGS. 9-13, the knee dissipating assembly 354.4 of the robot 1 includes a leg or upper energy attenuation member 808 coupled to the lower thigh 80 and a lower leg or lower energy attenuation member 848 coupled to a rear portion of the shin 84. The knee energy attenuation members 808, 848 are configured to contact each other when the robot 1 bends its knees. As described above, the inclusion of the energy attenuation members 808, 848 increases the range of motion of the robot's knee and gives the robot a human-like configuration. The knee energy attenuation members 808, 848 are configured such that when the leg is bent at the knee, the knee energy attenuation members 808, 848 compress to limit the movement of the shin 84 toward the lower thigh 80.

The knee dissipating assembly 354.4 may optionally include a rear deformable member 846.2 coupled to the shin 84 in addition to the lower leg energy attenuation member 848. The rear deformable member 846.2 and the lower leg energy attenuation member 848 may be made of energy attenuating materials that are of different densities. For example, the rear deformable member 846.2 may be formed from a material of a first density and the lower leg energy attenuation member 848 of a second density. For example, the lower leg energy attenuation member 848 may be made of one energy attenuating material and the rear deformable member 846.2 may be made of another energy attenuating material, such as the same material as the deformable member 845.2 of the knee protective assembly 352.4. In other embodiments, the rear deformable member 846.2 may be omitted, and the lower leg energy attenuation member 848 may be made from an energy attenuating material of two different densities. Further, the leg energy attenuation member 808 coupled to the lower thigh 80 may match the materials and/or composition of the lower energy attenuation member 848. For example, both energy attenuation members 808, 848 may be made from an energy attenuating material of a first density and an energy attenuating material of a second density.

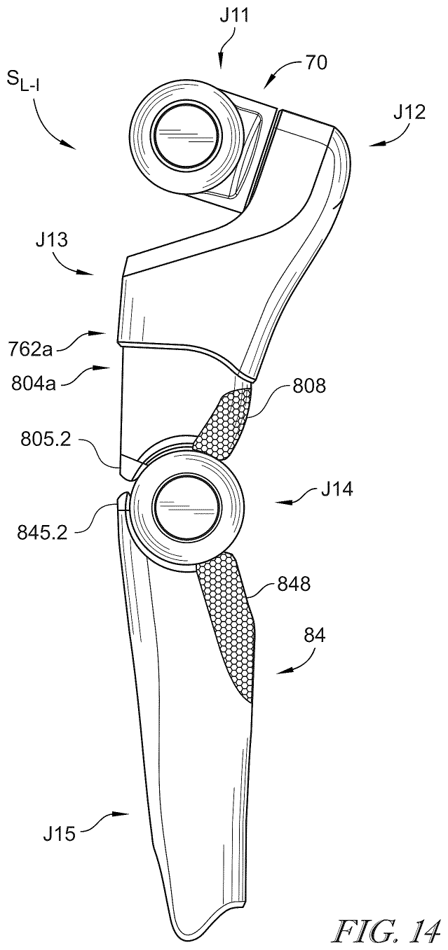

As best shown in FIGS. 14-19, the internal assembly includes: (i) an upper internal deformable member 808b that is coupled to a rear or internal region of the leg that is adjacent to the knee, and specifically is coupled to a rear region of the lower thigh, and (ii) a lower internal deformable member 848b that is coupled to a rear or internal region of the leg that is adjacent to the knee, and specifically is coupled to a rear region of the shin. The rear portion of the lower thigh includes a thigh cover that is removably coupled to the frame of the lower thigh. The thigh cover may be configured to be removed to access the hip Z actuator. The interior surface of the thigh cover includes ribs to increase the stiffness of the thigh cover. In other embodiments, the ribs may be omitted, their thickness may be increased, or fewer ribs may be used. Additionally, it should be understood that in other embodiments, the thigh cover may be omitted and instead may be integrally formed as a part of the frame. Additionally, the rear portion of the shin includes a cover that is removably coupled to the frame of the shin. The shin cover is configured to be removed to access the shin actuator. The interior surface of the shin cover includes ribs to increase the stiffness of the shin cover. In other embodiments, the ribs may be omitted, their thickness may be increased, or fewer ribs may be used. Additionally, it should be understood that in other embodiments, the shin cover may be omitted and instead may be integrally formed as a part of the frame.

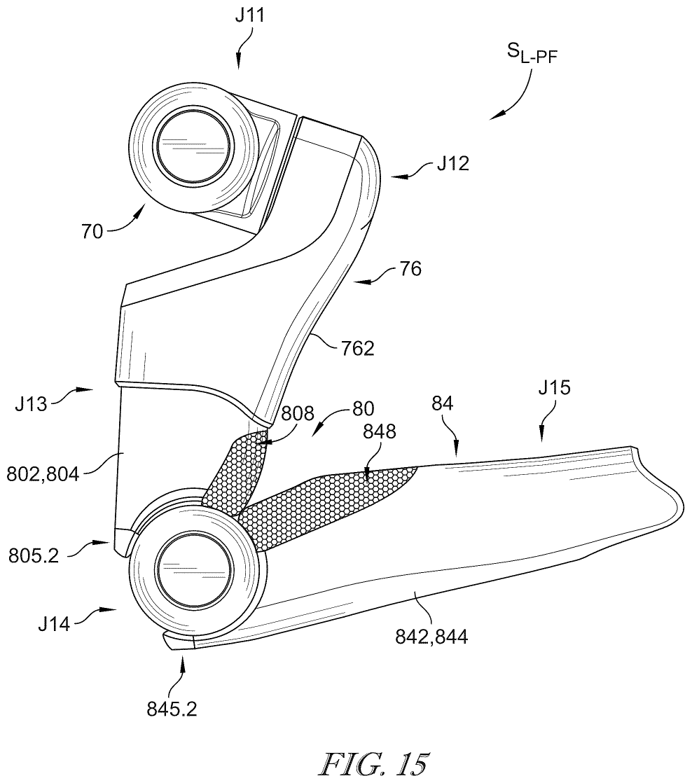

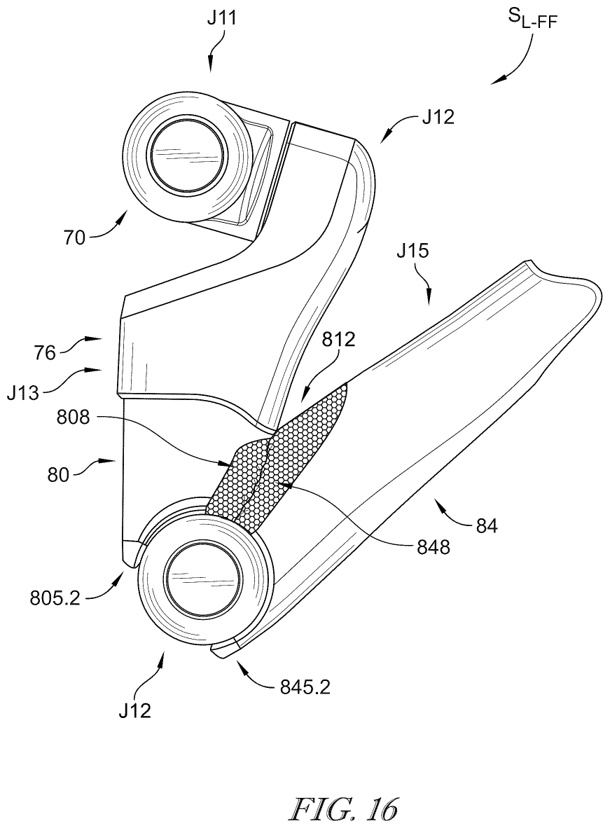

As shown in FIGS. 15-16, the deformable members 808b, 848b are: (i) partially compressed in FIG. 15, when the leg is partially flexed, and (ii) fully compressed in FIG. 16, when the leg is fully flexed. The compression of the deformable members 808b, 848b limits the movement of the shin to the lower thigh by gradually applying additional resistive pressure. Once the resistive pressure is great enough, a sensor contained in the knee actuator will prevent the leg from further flexing. As such, the knee actuator may not include a hard stop. In other embodiments, the knee actuator may include both a hard stop and the internal assembly. It should be understood that the hard stop may be: (i) a physical hard stop that is integrally formed within the actuator or in adjacent components of the actuator, or (ii) a digital hard stop that is software based.

### 2. Knee Protective Assembly

Referring to FIGS. 16-19, the knee protective assembly 352.4 includes an upper knee guard 805 coupled to the frontal portion of the lower thigh 80 and a lower knee guard 845 coupled to the frontal portion of the shin 84. The upper knee guard 805 includes a deformable member 805.2 and a replaceable guard plate 805.4, and the lower knee guard 845 includes a deformable member 845.2 and a replaceable guard plate 845.4.

The upper knee guard 805, including a deformable member 805.2 and a replaceable guard plate 805.4, is coupled to a frontal portion of the lower thigh 80. A lower external extent of the lower thigh frame 804 includes an end stop mount 804.8 configured to receive a deformable member 805.2 that faces a deformable member 845.2 of the shin 84, where the deformable members 805.2, 845.2 are configured to impact each other to prevent over-rotation at the front of the knee. The replaceable guard plate 805.4 is configured to couple with an external mount portion 804.8.2 of the shin frame 844 in the front lower portion of the lower thigh 80 above the deformable member 805.2. The replaceable guard plate 805.4 may be made of the same or a different material as the lower thigh frame 804. In some embodiments, the replaceable guard plate 805.4 may include energy attenuating materials.

Similarly, the lower knee guard 845, including a deformable member 845.2 and a replaceable guard plate 845.4, is coupled to a frontal portion of the shin 84. An upper external extent of the shin frame 844 includes an end stop mount 844.8 configured to receive a deformable member 845.2 that faces a deformable member 805.2 of the lower thigh 80, where the deformable members 805.2, 845.2 are configured to impact each other to prevent over-rotation at the front of the knee. The replaceable guard plate 845.4 is configured to couple with an external mount portion 844.8.2 of the shin frame 844 in the front upper portion of the shin 84 below the deformable member 845.2. The replaceable guard plate 845.4 may be made of the same or a different material as the shin frame 844 or the rear access panel 846. In some embodiments, the replaceable guard plate 845.4 may include energy-attenuating materials.

The end stop mounts 804.8, 844.8 are formed such that the deformable member mounting surfaces 804.8.4, 844.8.4, and attached replaceable deformable members 805.2, 845.2, are substantially parallel to the axis of rotation of the knee actuator 820. The deformable members 805.2, 845.2 are spaced apart when the knee is in a normal position. The end stop mounts 804.8, 844.8 and deformable members 805.2, 845.2 are configured such that when the knee is hyperextended, the deformable members 805.2, 845.2 impact each other, which limits further movement. The deformable members 805.2, 845.2 may be made from any material, preferably a deformable one, which includes plastics or polymers, and the energy-absorbing materials listed below with respect to the energy attenuation members 808, 848.

As shown in FIGS. 1A-1B and 9-19, an external extent of the lower thigh housing 802 includes an end stop mount 804.8. The end stop mount 804.8 includes an external mount portion 804.8.2 and a deformable surface 804.8.4. The lower thigh housing 802 is shaped such that an external surface portion 804.8.2 tapers from the lower thigh coupling assembly 804.2 to the deformable surface 804.8.4 positioned at an external extent of the actuator receiving assembly 804.6. The external mount portion 804.8.2 is configured to couple with a replaceable guard plate 805.4 and may include ribs 804.8.2.2 for additional structural support. The deformable surface 804.8.4 is configured to receive an upper deformable member 805.2 that is fastened to the deformable surface 804.8.4. The deformable surface 804.8.4 may also have an end stop projection 804.8.8 extending from the surface that is configured to mate with the deformable member 805.2. The end stop projection 804.8.8 may be made of the same or a different material as the housing 802.

Similarly, an external extent of the shin housing 842 includes an end stop mount 844.8 that faces the end stop mount 804.8 of the lower thigh 80. The end stop mount 844.8 includes an external mount portion 844.8.2 and a deformable surface 844.8.4. The shin housing 842 is shaped such that an external surface portion of 844.8 tapers from the shin body 844.4 to a deformable surface of 844.8.4, which is positioned along an extent of the knee coupling assembly 844.2. The external mount portion 844.8.2 is configured to couple with a replaceable guard plate 845.4 and may include ribs 844.8.2.2 for additional structural support. The deformable surface 844.8.4 is configured to receive a lower deformable member 845.2 that is fastened to the deformable surface 844.8.4. The deformable surface 844.8.4 may also have an end stop projection 844.8.8 extending from the surface configured to mate with the lower deformable member 845.2. The end stop projection 844.8.8 may be made of the same or a different material as the housing 842.

The end stop mounts 804.8, 844.8 are formed such that the deformable surfaces 804.8.4, 844.8.4, and attached replaceable deformable members 805.2, 845.2, are substantially parallel to the axis of rotation of the knee actuator 820. The deformable members 805.2, 845.2 are spaced apart when the knee is in a normal position. The end stop mounts 804.8, 844.8 and deformable members 805.2, 845.2 are configured such that when the knee is hyperextended, the deformable members 805.2, 845.2 impact each other, which limits further movement. The deformable members 805.2, 845.2 may be made from any material, which includes plastics or polymers.

### 3. Knee Kinematics

FIGS. 14-19 generally relate to the range of motion and associated kinematics of the leg 6 about the knee of the robot 1. In particular, the lower leg assembly 6.2, including the shin 84, talus 88, and foot 92, extends from the knee actuator (J14) 820. In FIG. 16, the leg assembly of the robot 1 is shown in a normal position S_{L-I}, where the robot 1 is standing in an upright position, as shown in at least FIG. 1. The leg 6 is considered in a flexion position S_{L-PF} as the knee bends such that the rear portions of the shin 84 and lower thigh 80 move toward each other. The leg 6 is considered in a hyperextended position S_{L-HE} as the knee bends such that the frontal portions of the shin 84 and lower thigh 80 at deformable members 805.2, 845.2 move toward each other. For example, the knee's range of motion ranges from about −1 to −140 degrees (flexed), to normal at 0 degrees, and to about 1 to 20 degrees (hyperextended). In other words, the total range of motion of the knee is greater than 80 degrees, preferably greater than 120 degrees, and most preferably between 140 degrees and 160 degrees.

In the flexion position, as shown in FIGS. 15 and 16, contact and compression of the energy attenuation members 808, 848 begins at about 110 degrees. The knee energy attenuation members 808, 848 are configured to compress to limit the movement of the shin 84 toward the lower thigh 80. Although the energy attenuation members 808, 848 are in contact, the leg 6 may continue to bend until a second range of motion limit, at about 160 degrees, as shown in FIG. 16. The energy attenuation members 808, 848 temporarily deform with compression and may return to their previous form when the members 808, 848 are no longer in contact.

In a hyperextended position S_{L-HE}, as shown in FIGS. 17-19, the lower thigh 80 and shin 84 are moved in opposite directions such that front portions of the shin 84 and lower thigh 80 move toward each other. The hyperextended position S_{L-HE} is a first range of motion limit, and the deformable members 805.2, 845.2 impact each other at about at least 5 degrees, preferably at least 10 degrees, and most preferably at least 15 degrees.

The deformable members 808b, 848b, 805.2, 845.2 of the internal and external assemblies may be sacrificial parts that can be replaced when they break. Certain components contained in the external dissipating assembly may be made from plastic and can have a first density and a first compression/deflection ratio, while certain components contained in the internal dissipating assembly may include urethane and can have a second density and a second compression/deflection ratio. The disclosed second density and second compression/deflection ratio may be less, and in certain situations, substantially less (e.g., more than 50%), than the first density and first compression/deflection ratio. In other embodiments, certain components contained in the internal dissipating assembly may include two regions: a first region having a third region density and a third region compression/deflection ratio, and a second region having a fourth region density and a fourth region compression/deflection ratio. The fourth region density and fourth region compression/deflection ratio are greater than the third region density and third region compression/deflection ratio. In this embodiment, the fourth region is positioned adjacent to the panel, frame, or housing and is surrounded, or partially surrounded, by the third region.

The actuators in robot 1 are configured to provide a range of motion. Generally, the knee actuator 820 is configured to bend to substantially mimic a human's movements. FIGS. 14-17 generally relate to the range of motion and associated kinematics of the knee 81 of the robot 1. The leg assembly 6 of the robot 1 is shown in a normal position in FIG. 14, where the robot 1 is standing upright, as shown in at least FIG. 1. The leg 6 is considered in a partially flexed position S_{L-PF} as the knee bends such that the shin 84 and lower thigh 80 move toward each other, as shown in FIG. 15. Compression of the energy attenuation members 808, 848 begins at about 110 degrees and continues until the range of motion limit, at about 160 degrees, as shown in FIG. 16. FIG. 17 shows the leg assembly 6 in a hyperextended position S_{L-HE}, where the lower thigh and shin are moved in opposite directions until the range of motion limit, when the deformable members 805.2, 845.2 impact each other, at about at least 5 degrees, preferably at least 10 degrees, and most preferably at least 15 degrees.

The inclusion of the knee energy attenuation members 808, 848 may facilitate a smoother range of motion and a more natural, human-like appearance for the robot 1. When the leg 6 is bent or flexed, the knee energy attenuation members 808, 848 are compressed to limit the movement of the lower thigh 80 toward the shin 84 by gradually applying additional resistive pressure Pr as the lower thigh 80 continues to move towards the shin 84. In light of the application of the additional resistive pressure Pr, an opposed compressive pressure Pc will be applied by the lower knee energy attenuation member 848 on the upper knee energy attenuation member 808. Like the resistive pressure Pr, the compressive pressure Pc will increase as the second assembly, or the lower knee energy attenuation member 848, further compresses or moves from a partially flexed to a fully flexed S_{L-FF}. However, a sensor contained within the robot 1 will not allow the compressive pressure Pc to exceed a predetermined pressure value on an external object that is positioned between the lower knee energy attenuation member 848 and the upper knee energy attenuation member 808. In other words, the robot 1 will stop moving the lower knee energy attenuation member 848 towards the upper knee energy attenuation member 808 if and when the compressive pressure Pc exceeds the predetermined pressure value on an external object. The predetermined pressure value may be any value between 25 N/cm² to 800 N/cm², preferably between 100 N/cm² to 400 N/cm², and most preferably between 150 N/cm² to 350 N/cm². For example, said predetermined pressure value may be 110 N/cm², 170 N/cm², 200 N/cm², 220 N/cm², or 300 N/cm².

It should be understood that the compressive pressure Pc will also result in a compressive force Fc that is also applied to the external object. Thus, it should also be understood that a sensor contained within the robot 1 will not allow the compressive force Fc to exceed a predetermined force value on an external object that is positioned between the lower knee energy attenuation member 848 and the upper knee energy attenuation member 808. In other words, the robot 1 will stop moving the lower knee energy attenuation member 848 towards the upper knee energy attenuation member 808 if and when the compressive force Fc exceeds the predetermined force value on an external object. The predetermined force may be any value between 25 N to 500 N, preferably between 50 N to 250 N, and most preferably between 130 N to 210 N. For example, said predetermined force value may be 65 N, 130 N, 140 N, 180 N, or 220 N.

For example, if a human finger (e.g., having an average diameter of 16-20 mm) were placed between the lower knee energy attenuation member 848 and the upper knee energy attenuation member 808, the robot 1 may continue moving the lower knee energy attenuation member 848 towards the upper knee energy attenuation member 808 and about the rotational axis until the compressive pressure exerted between the lower knee energy attenuation member 848 and the upper knee energy attenuation member 808 reaches 250 N/cm² on the human finger. Once a compressive pressure that exceeds 250 N/cm² is applied to said human finger, the robot 1 will stop or be unable to move the lower knee energy attenuation member 848 further towards the upper knee energy attenuation member 808 and about the rotational axis. In another example, if a human arm (e.g., having an average diameter of 9-11 cm) were placed between the first assembly, or the housing 802 of the lower thigh 80, and the second assembly, or the housing of the shin 84, the robot 1 may continue moving the second assembly, or the housing of the shin 84, towards the first assembly, or the housing 802 of the lower thigh 80, and about the knee axis until the compressive pressure that is exerted between the first assembly, or the housing 802 of the lower thigh 80, and the second assembly, or the housing of the shin 84, reaches 180 N/cm² on the human arm. Once a compressive pressure that exceeds 180 N/cm² is applied to said human arm, the robot 1 will stop or be unable to move the first assembly, or the housing of the shin 84, towards the second assembly, or the housing 802 of the lower thigh 80, and about the knee axis.

Likewise, if a human finger (e.g., having an average diameter of 16-20 mm) were placed between the lower knee energy attenuation member 848 and the upper knee energy attenuation member 808, the robot 1 may continue moving the lower knee energy attenuation member 848 towards the upper knee energy attenuation member 808 and about the rotational axis until the compressive force that is exerted between the lower knee energy attenuation member 848 and the upper knee energy attenuation member 808 reaches 140 N on the human finger. Once a compressive force that exceeds 140 N is applied to said human finger, the robot 1 will stop or be unable to move the lower knee energy attenuation member 848 further towards the upper knee energy attenuation member 808 and about the rotational axis. In another example, if a human arm (e.g., having an average diameter of 9-11 cm) were placed between the first assembly, or the housing 802 of the lower thigh 80, and the second assembly, or the housing of the shin 84, the robot 1 may continue moving the second assembly, or the housing of the shin 84, towards the first assembly, or the housing 802 of the lower thigh 80, and about the knee axis until the compressive force exerted between the first assembly, or the housing 802 of the lower thigh 80, and the second assembly, or the housing of the shin 84, reaches 160 N on the human arm. Once a compressive force that exceeds 160 N is applied to said human arm, the robot 1 will stop or be unable to move the second assembly, or the housing of the shin 84, further toward the first assembly, or the housing 802 of the lower thigh 80, and about the knee axis.

It should also be understood that the robot 1 is designed to ensure that the compressive force or compressive pressure shall never apply a flexed pressure or flexed force on an external object. It should be understood that this flexed pressure or flexed force is regardless of any measurement system (e.g., torque cell, pressure sensor, or force sensor) that is included within the robot 1. In other words, said robot 1 can only apply a flexed pressure or flexed force that is less than a predetermined flexed pressure or predetermined flexed force in the fully flexed position. Said predetermined flexed pressure may be any value between 25 N/cm² to 800 N/cm², preferably between 100 N/cm² to 400 N/cm², and most preferably between 150 N/cm² to 350 N/cm² and the predetermined flexed force may be any value between 25 N to 500 N, preferably between 50 N to 250 N, and most preferably between 130 N to 210 N. For example, when the knee joint is in the fully flexed position S_{L-FF}, a force that is less than 140 N is applied to an object that is positioned between an extent of the upper knee energy attenuation member 808 and the lower knee energy attenuation member 848.

The above described compressive force or compressive pressure may be measured using any known method, including using: (i) the torque cells contained within the actuators, or (ii) an external pressure or force sensor, including any pressure or force sensor described herein. As shown in FIG. 16, the energy attenuation members 808, 848 will become fully compressed when the leg 6 reaches the fully flexed position S_{L-FF}. This design results in more fluid, lifelike movements and can potentially increase the usable range of motion compared to designs with harsh hard stops. In contrast, a purely rigid design might inherently have much less range of motion, or achieving a comparable range of motion could necessitate designing recesses or cut-outs in the shin 84 and/or the lower thigh 80 to avoid interference, which may potentially compromise structural integrity. As such, the first assembly, or lower thigh 80, includes a first interior point P₈₁ and a first exterior point P₈₂, and wherein the knee axis A₁₄ is substantially centered between the first interior and exterior points P₈₁, P₈₂. Likewise, the second assembly, or shin 84, includes a second interior point Pas and a second exterior point P₈₆, and wherein the knee axis is substantially centered between the second interior and exterior points P₈₅, P₈₆. It should be understood that the interior points P₈₁, Pas and exterior points P₈₂, P₈₆ are positioned on an outermost extent of said lower thigh 80 and/or shin 84, and as such they may be positioned exterior to the housing of said lower thigh 80 and/or shin 84. For example, said points may be positioned on the upper knee energy attenuation member 808, or a member that covers the upper knee energy attenuation member 808, and/or the lower knee energy attenuation member 848, or a member that covers the lower knee energy attenuation member 848.

Also, as shown in FIG. 16, when the leg 6 reaches the fully flexed position S_{L-FF}, a gap 812 is formed between an outer surface 802.2 of the lower thigh housing 802 and an outer surface 842.2 of the shin housing 842. Said gap 812 has a predetermined width that may be greater than 0.25 inches (or 0.635 centimeters). While said gap 812 is occupied by the energy attenuation members 808, 848, said gap 812 is positioned between the outer surface 802.2 of the lower thigh housing 802 and an outer surface 842.2 of the shin housing 842 to help ensure or eliminate a pinch point between the lower thigh housing 802 and the shin housing 842. It should be understood that the size of the gap may be increased or may be eliminated in alternative embodiments.

In addition to the rotational axis being substantially centered along the leg, the first assembly, or lower thigh 80, lacks a recess configured to receive an extent of the knee actuator in a fully flexed position S_{L-FF}. While a recess 802.5 is formed in the housing 802 of the first assembly, or the housing 802 of the lower thigh 80, said recess 802.5 is occupied by the upper knee energy attenuation member 808 and thus the overall first assembly, or lower thigh 80, lacks a recess. Further, the second assembly, or shin 84, lacks a recess configured to receive an extent of the knee actuator in a fully flexed position S_{L-FF}. While a recess 842.5 is formed in the housing 842 of the second assembly, or the housing 842 of the shin 84, said recess 842.5 is occupied by the lower knee energy attenuation member 848 and thus the overall second assembly, or shin 84, lacks a recess. It should be understood that the above disclosure is focused on a substantial recess that is configured to receive an extent of the knee actuator and is not focused on minor deviations in the assemblies 80, 84. As such, said lack of recesses focuses on a recess that has a depth greater than 5 mm at a location and is designed to receive an extent of the knee actuator. Overall, the lack of an external recess enables the leg to appear more streamlined, aesthetically pleasing, and provides a human-like appearance for the knee joint (J14) 820. Designs relying solely on rigid components might require visible recesses, offsets, or bulky external stops to manage the range of motion, which can look unnatural. Soft members, such as the energy attenuation members 808, 848, can be integrated more smoothly into the joint's contours, contributing to a more organic and less mechanical look for the robot 1.

The inclusion of the knee energy attenuation members 808, 848 can also significantly enhance the mechanical protection of the knee joint (J14) and reduce stress on its internal parts. By acting as a buffer, the deformable members absorb and dissipate energy when the joint reaches its end of travel. This casing of the hard stop reduces the impact forces, distributing them over a slightly longer duration and larger area. This lessens wear and tear on components like gears, bearings, and actuators, preventing damage and potentially extending the operational lifespan of the robot 1.

### K. Materials Included in the Members

The elbow energy attenuation member 368, deformable members 365, 405, knee energy attenuation members 808, 848, and deformable members 805.2, 845.2 may include one or more energy-absorbing materials, including any of the below-listed materials, structures, or any known material. The members 368, 365, 405, 808, 848, 805.2, 845.2 can be made of non-rigid, deformable, compressible, energy-absorbing, or other materials. In one example, the elbow energy attenuation member 368 can be made of two different densities of polyurethane. In another example, the knee energy attenuation members 808, 848 can be made of two different densities of polyurethane. In further examples, the members 368, 365, 405, 808, 848, 805.2, 845.2 can be made from and/or include: polyethylene foam (PE foam), cross-linked polyethylene foam (XLPE), ethylene vinyl acetate (EVA) foam, polyurethane foam (PU foam), memory foam, open-cell polyurethane foam, reticulated polyurethane foam, microcellular urethane (MCU) foam, convoluted foam, polyimide foam, polyvinyl chloride (PVC) foam, expanded polystyrene (EPS), expanded polypropylene (EPP) foam, polyethylene terephthalate (PET) foam, melamine foam, phenolic foam, syntactic foam, neoprene foam, silicone rubber foam, nitrile butadiene rubber (NBR) foam, ethylene propylene diene monomer (EPDM) foam, vinyl nitrile foam, thermoplastic elastomer (TPE) foam, elastomeric foam, butyl rubber foam, styrene-butadiene rubber (SBR) foam, latex foam (natural or synthetic), cellulose foam, wood foam, Koroyd®, D30®, Poron® XRD, aerogel (e.g., silica aerogel), acrylonitrile butadiene styrene (ABS), polyamide (PA or nylon, including PA6, PA66, PA11, PA12), polycarbonate (PC), polyethylene (PE, including LDPE, HDPE, UHMWPE), polyethylene terephthalate (PET), polyethylene terephthalate glycol (PETG), polylactic acid (PLA), polymethyl methacrylate (PMMA/acrylic), polypropylene (PP), polystyrene (PS, including HIPS), polytetrafluoroethylene (PTFE/Teflon®), polyvinyl chloride (PVC), polyvinylidene fluoride (PVDF), polyether ether ketone (PEEK), polyetherimide (PEI/Ultem®), polysulfone (PSU), polyphenylene sulfide (PPS), polyoxymethylene (POM/Acetal/Delrin®), acrylonitrile styrene acrylate (ASA), styrene acrylonitrile (SAN), polyhydroxyalkanoates (PHA), polyhydroxybutyrate (PHB), ethylene propylene diene monomer (EPDM), fluoroclastomers (FKM/Viton®), natural rubber (isoprene), nitrile butadiene rubber (NBR), polyurethane (PU), silicone rubber (VMQ, FVMQ), thermoplastic elastomers (TPE), thermoplastic polyurethane (TPU), butyl rubber (IIR), styrene-butadiene rubber (SBR), thermoplastic vulcanizates (TPV), thermoplastic polyolefins (TPO), copolyester elastomers (COPE), multi-layered foams, fiberglass foam composites, metalized foam composites, carbon fiber foam composites, foam core laminates, stereolithography (SLA) resins (various formulations: standard, tough, flexible, castable, high temp), selective laser sintering (SLS) powders (e.g., PA11, PA12, TPU powders), fused deposition modeling (FDM) filaments (beyond basic PLA/ABS, including PETG, ASA, PC blends, nylon blends), CE221, EPU40, EPU 41, EPU43, EPU 44, EPU 45, EPU 46, EPX82, EPX 86, EPX 150, FPU 50, MPU 100, RPU 70, RPU 130, SIL 30, any other known plastics, any combination of the above, and/or any other material known to one of skill in the art, among any materials, structures listed below or any other known materials.

The members 368, 365, 405, 808, 848, 805.2, 845.2 may be 3D printed, additively manufactured, injection molded, milled, or fabricated using any other known methods. Further, the members 368, 365, 405, 808, 848, 805.2, 845.2 may include any known structure of the materials, wherein the structures may include lattices, non-repeating units, and/or repeating units (e.g., cube, sphere, cylinder, cone, pyramid, torus, prism, tetrahedron, dodecahedron, octahedron, icosahedron, ellipsoid, paraboloid, cuboid, hexahedron). It should be understood that the repeating unit or lattice cell may be contained in a specific region or may propagate throughout the members 368, 365, 405, 808, 848, 805.2, 845.2. As such, the members 368, 365, 405, 808, 848, 805.2, 845.2 may include multiple different regions that each include a unique selection of: (i) material, including its chemical composition, (ii) properties, including mechanical and/or material based, (iii) shape, including lattice cells (e.g., surface or strut-based) or material-based shapes (e.g., porous materials), (iv) arrangements of shapes, etc. For example, variations between materials, properties, shapes, and/or arrangement of the shapes can be optimized through computer simulation (FEA) to optimize the energy attenuation member or assembly for local loading conditions.

### L. Alternative Components of the Rotational Limiting System

Other embodiments of the energy attenuation members 368, 808, 848 may combine various advanced materials and architectural designs to absorb and dissipate impact energy across multiple scales. In one embodiment, multi-layered composite structures may incorporate phase-change materials (PCMs), such as microencapsulated paraffin wax embedded within high-performance polymer matrices. These PCMs absorb energy during thermal transitions from solid to liquid states, with the encapsulation size and concentration tuned to specific load conditions. Similarly, functionally graded materials (FGMs) or other multi-layered assemblies may be utilized, wherein the material composition or layers vary—from a stiff, impact-resistant outer layer to a soft, more compliant, energy-dissipative inner core—to optimize load distribution. Alternatively, the FGMs or multi-layered assemblies may vary from a soft, more compliant outer layer to a stiff, impact-resistant inner core. Further and as discussed above, the FGMs or multi-layered assemblies' material composition or layers may vary in stiffness or have other properties that vary laterally. In summary, the stiffness or other properties of the energy attenuation member or assembly may vary across the depth of the member, laterally across the width, vertically across the height, or any combination thereof. Such FGMs or multi-layered assemblies can be further enhanced by incorporating gradient nanocomposites, where nanoparticles or nanofibers are dispersed in controlled gradients to tailor mechanical responses. In other examples, FGMs or multi-layered assemblies may include alternating layers of rigid and flexible materials to dissipate impact forces. Further, these composite attenuation members may be strategically located in critical regions, such as joints, limb segments, and torso sections, where localized energy dissipation is most needed.

Additional embodiments may integrate adaptive damping mechanisms using smart fluids and electromechanical components. For example, magnetorheological (MR) fluids or magnetorheological elastomers (MREs) are contained within flexible pouches or embedded channels; when subjected to controlled magnetic fields generated by integrated coils, their viscosity or stiffness rapidly increases, enabling real-time adjustment of damping properties. Additionally, or alternatively, the energy attenuation members may include compressible chambers with optional microfluidic networks, and wherein the chambers may be filled with hydrogel, air, or any other liquid or gas. Further enhancements include shear-thickening fluids (STFs) impregnated in flexible fabrics, which instantly stiffen under high strain rates, and electroactive polymers that modify their mechanical properties upon exposure to electrical stimuli. Finally, the energy attenuation members 368, 808, 848 may include: (i) origami-inspired folding structures that could be integrated into the attenuation members, wherein the structures are designed to allow for controlled deformation and energy absorption, (ii) sacrificial structures designed to plastically deform or fracture in a controlled manner during high-energy impacts, and/or (iii) Kirigami-inspired structures that include engineered cut patterns that are designed to allow for controlled out-of-plane deformation and energy absorption, while maintaining in-plane flexibility.

Additionally and/or alternatively, the robot 1 may include integrated damping systems employed near the joint limits. These systems would utilize miniature hydraulic, pneumatic, or electromagnetic (e.g., eddy current), dampers designed to provide velocity-dependent resistance. Structurally, a small hydraulic damper, for instance, could be mounted parallel to the primary joint axis, with its body anchored to the frame, e.g., 364 of one segment, e.g., lower humerus 36 and its piston rod connected to the frame, e.g., 404 of the adjoining segment, e.g., upper forearm 40. As the joint approaches its angular limit at speed, the damper actively resists the motion, converting kinetic energy into heat and providing smooth deceleration without the potentially abrupt end-stop feel of purely elastic materials. This approach primarily handles energy dissipation, potentially allowing the existing attenuation members to be optimized for shape, cushioning, and lower-speed compression characteristics.

Further, the robot 1 may include non-contact magnetic stops. This system would involve embedding high-strength permanent magnets, e.g., neodymium magnets, into opposing surfaces of the joint segments that approach each other at the rotation limits (e.g., rear surfaces of lower humerus 36 and upper forearm 40 for the hyperextension limit; front surfaces for the flexion limit). They are oriented such that like poles face each other. As the joint approaches the limit angle, the magnets get closer, and the repulsive magnetic force between these embedded magnets provides a strong decelerating force, creating a “soft” stop without physical contact. This could replace or supplement the function of the deformable members, e.g., 365, 405, 805.2, 845.2. The interface requires secure mounting pockets within the structural frames 364, 404, 804, 844 or potentially within specialized mounting plates attached to the frames, replacing the deformable contact members and potentially the energy attenuation members 368, 808, 848 if the magnetic force profile is sufficient. The field strength and magnet placement would need careful design to provide the desired stopping force profile within the available space and without interfering with other components like sensors.

Additionally and/or alternatively, the robot 1 may also utilize its control system and sensors to enforce limits primarily through software. Utilizing high-resolution joint encoders integrated with the actuators (e.g., elbow actuator (J4) 374, knee actuator (J14) 820), the motion controller continuously tracks the precise joint angle. Pre-defined angular limits, or “virtual walls,” are set within the control software. As the calculated or measured angle approaches these limits, the controller proactively commands the actuator to decelerate and apply counter-torque to prevent motion beyond the defined boundary. Finally, hybrid approaches may be utilized that combine one or more aspects of the above disclosure.

### M. Elbow, Knee, and Other Housings

The housing or exoskeleton needed for the assemblies of various components of robot 1 can vary in shape and form based on individual structural and/or material requirements for the specific components (e.g., torso, shoulder, head, etc.). Although it may be desirable to utilize a particular material for all the housings to have a consistent exterior appearance for the robot 1, fabrication may be complicated by the varying structural or operational needs at different robot positions. It may not be necessary to utilize the same materials in different component housings that have different load requirements. Various materials may be preferred for a specific component housing based on strength, toughness, elasticity, yield point, strain energy, resilience, elongation during load, weight, conductivity, etc. Similarly, the complexity of some housing designs may be better suited for one type of manufacture over another. Various fabrication methods of the housing components can include machining, die casting, injection molding, compression molding, composite fabrication, etc. For example, some housings may be cast metal instead of machined metal to achieve the desired cost, form, speed of manufacturing, and mechanical properties.

To hide the fact that different fabrication methods or materials may be used, or to cover the finishes caused by the fabrication methods or the materials themselves, it may be advantageous to obscure the exterior of housings using an exterior covering system 347. The exterior covering system 347 may provide additional benefits as it can be easily replaced if damaged, protects internal components from dust and debris, conforms to the robot's form without excessive wrinkling, is generally inexpensive, and accommodates ventilation and thermal regulation needs. Further, the exterior covering system 347 may not impede the robot's 1 range of motion, can maintain access to underlying components, and allow for access and/or operation of indicators or other functional elements (e.g., buttons, levers, etc.) on the robot's exterior surface. The exterior covering system 347 may include attachment mechanisms for secure, detachable mounting at multiple locations, such as the collar, waist, sleeves, ankles, etc. Multi-point attachment ensures a snug fit, reducing the risk of interference between the robot 1 and factory equipment. In some instances, the cover members 347.2 of the exterior covering system 347 can attach directly to the surface of specific components or their portions. The exterior covering system 347 is constructed from highly durable textiles with high stretch capabilities and resistance to pilling, abrasions, and cuts.

The disclosed exterior covering system 347 for the humanoid robot 1 is form-fitting, meaning it is neither loose nor detached by more than a small margin (e.g., between 1 inch and 5 inches, preferably 3 inches) from the robot's exterior surface or the outer surface of the energy dissipation assemblies 354.2, 354.4 without becoming disconnected. In other words, rather than draping loosely over the robot's frame, the exterior covering system 347 is precisely and securely fitted to specific regions. The exterior covering material may exhibit an elongation or stretch percentage exceeding 10% (preferably more than 30%, and most preferably greater than 50%), ensuring that when affixed to the robot 1, it remains under tension to conform closely to the robot's structure. Furthermore, a single cover member 347.2 does not cover or surround all actuators within the robot 1, a majority of the actuators contained in an upper portion of the robot 1, nor does it typically enclose more than three actuators at a time. In other words, the single cover member 347.2 does not resemble an oversized jumpsuit with a single zipper extending from the pelvis to the head region. Additionally, it does not feature a hood that covers a substantial portion of the robot's head. Instead, the exterior covering system 347 may be designed to include textile inserts positioned strategically between moving joint components to further ensure that pivoting motion is not restricted at the robot's joints. Different textile patterns are incorporated to facilitate movement in specific regions, enhancing the robot's functional dexterity.

The humanoid robot 1 may also integrate an internal energy management assembly 349 comprising multiple energy attenuation members 368, 808, 848. These members 368, 808, 848 may be positioned beneath the exterior coverings and in contact with certain housings (e.g., 362, 802, 842), contributing to impact absorption and structural integrity. The inclusion of energy attenuation members 368, 808, 848 is beneficial for protecting the robot 1 during operation and interaction with its environment. These members 368, 808, 848 may be strategically placed adjacent to particular housings or specific portions thereof to provide additional support and protection to underlying components. The energy attenuation members 368, 808, 848 are composed of non-rigid, deformable, compressible, or energy-absorbing materials. For example, component housings may include coupling features designed to accommodate energy attenuation members 368, 808, 848, particularly in interference zones where excessive rotation could result in a component collision. The energy attenuation members 368, 808, 848 can be designed as detachable and replaceable elements. Depending on the embodiment, they may be coupled directly to the housing, surround the housing, or be secured via the cover members 347.2. These features allow for modularity, enabling the replacement or removal of energy attenuation members 368, 808, 848 as needed.

### N. Industrial Application

Based on the above description, it should be understood that the disclosed robot 1 meets, exceeds, and/or can obtain a low qualifying score in connection with ISO 15066, ANSI R15.606, ISO 13854, ISO 13857, and/or ANSI B11.19, each of which latest version, that is publicly available as of the filing date of this Application, is fully incorporated herein by reference. In other words, the disclosed robot 1 can be certified to ISO 15066, ANSI R15.606, ISO 13854, ISO 13857, and/or ANSI B11.19. The disclosed robot 1 may also meet, exceed, or can receive a score in connection with ISO 10218-1, -2, ANSI R15.06, ISO 12100, ISO 13849-1, IEC 62061, ANSI B11.0, ANSI R15.08-1, ISO 3691-4, and/or any part of extent thereof, as each of which latest version, that is publicly available as of the filing date of this Application, is fully incorporated herein by reference.

While the above described components are configured for use with a general purpose humanoid robot, it should be understood that the components may be used with other robots. Examples of other robots include: articulated robot (e.g., an arm having two, six, or ten degrees of freedom, etc.), a cartesian robot (e.g., rectilinear or gantry robots, robots having three prismatic joints, etc.), Selective Compliance Assembly Robot Arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servomotors and stepper motors), actuators, biasing members, encoders, housing, or any other component known in the art that is used in connection with robot systems.

The disclosed arm and leg assemblies lack hydraulics, hepatic force sensors, and cable-based actuators. In fact, the assemblies primarily rely on rotator-based actuators that utilize strain wave gears. This allows for the configuration of the arm and leg assemblies to be modular, utilize similar parts, and allow for the parts (e.g., actuators) to be assembled similarly. In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials, or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. It should also be understood that substantially utilized herein means a deviation less than 15% and preferably less than 5%. It should also be understood that near and proximate utilized herein means within 10 cm. It should also be understood that adjacent utilized herein means within 1 cm. It should also be understood that other configuration or arrangements of the above-described components is contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In thisapplicationn, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference. It should also be understood that structures and/or features not directly associated with a robot cannot be adopted or implemented into the disclosed humanoid robot without careful analysis and verification of the complex realities of designing, testing, manufacturing, and certifying a robot for completion of usable work nearby and/or around humans. Theoretical designs that attempt to implement such modifications from non-robotic structures and/or features are insufficient (and in some instances, woefully insufficient) because they amount to mere design exercises that are not tethered to the complex realities of successfully designing, manufacturing and testing a robot.

1. A humanoid robot comprising,
an actuator having a rotational axis and a momentary peak torque rating that is greater than 70 N-m;
a first assembly coupled to the actuator and including a first interior point and a first opposed, exterior point, and wherein the first assembly lacks a substantial recess configured to receive an extent of a second assembly in a fully flexed position;
the second assembly coupled to the actuator and including a second interior point and a second, opposed exterior point, and wherein the second assembly lacks a substantial recess configured to receive an extent of the first assembly in the fully flexed position; and
wherein the rotational axis is offset from a plane that extends between: (i) a center of a first distance that extends between the first interior and exterior points, and (ii) a center of a second distance that extends between the second interior and exterior points.

2. The humanoid robot of claim 1, wherein the first assembly includes a lower humerus housing and the second assembly includes an upper forearm housing, and wherein the actuator is an elbow actuator.

3. The humanoid robot of claim 2, wherein the elbow actuator lacks a housing that is separate from the lower humerus housing and the upper forearm housing.

4. The humanoid robot of claim 2, wherein a gap is formed between an outer surface of the lower humerus housing and an outer surface of the upper forearm housing in the fully flexed position; and
wherein said gap is greater than 0.635 centimeters.

5. The humanoid robot of claim 1, wherein the actuator is not a linear actuator, a hydraulic actuator, a cable-based actuator, or a pneumatic actuator.

6. The humanoid robot of claim 1, wherein the actuator includes a strain wave gearbox with a brushless DC motor.

7. The humanoid robot of claim 1, wherein the first assembly includes an energy attenuation member coupled to a first housing, and wherein the energy attenuation member is configured to be compressed by the second assembly when the actuator is in the fully flexed position.

8. The humanoid robot of claim 1, wherein if a pressure greater than 250 N/cm² is applied to an object by an extent of the first assembly and an extent of the second assembly when the second assembly is moving towards the first assembly about the rotational axis, then the humanoid robot will stop said movement of the second assembly towards the first assembly.

9. The humanoid robot of claim 1, wherein the offset is a distance that is less then 10 mm and extents between the rotational axis and the plane.

10. A humanoid robot comprising,
an actuator having an actuator axis and a momentary peak torque rating that is between 70 and 500 N-m;
a first housing coupled to the actuator;
a second housing coupled to the actuator;
wherein if a pressure greater than 250 N/cm² is applied to an object by an extent of the first housing and an extent of the second housing when the second housing is moving towards the first housing about the actuator axis, then the humanoid robot will halt said movement of the second housing towards the first housing.

11. The humanoid robot of claim 10, wherein a gap is formed between an outer surface of the first housing and an outer surface of the second housing in a fully flexed position; and
wherein said gap is greater than 0.635 centimeters.

12. The humanoid robot of claim 10, further comprising an energy attenuation member coupled to the first housing, wherein the energy attenuation member is configured to compress when the second housing is in the fully flexed position.

13. The humanoid robot of claim 12, wherein the energy attenuation member is coupled to only one of the first housing or the second housing.

14. A humanoid robot comprising,
a first housing:
a second housing;
a joint formed between the first housing and the second housing;
either of an energy attenuation member or an exterior cover coupled to one of the first housing or the second housing; and
wherein the humanoid robot will not apply a compressive force on an object that is positioned between the first and second housings that is greater than 130N.

15. The humanoid robot of claim 14, wherein the joint includes: (i) an actuator with a rotational axis, and (ii) the first housing has an interior point and an exterior point; and
wherein said rotational axis is substantially centered between the interior and exterior points of the first housing.

16. The humanoid robot of claim 15, wherein the rotational axis is offset from a center point between the interior and exterior points of the first housing by less than 10 mm.

17. The humanoid robot of claim 14, wherein the energy attenuation member is manufactured as a separate and distinct component and is then coupled to an outer surface of one of the first or second housings.

18. The humanoid robot of claim 14, wherein the energy attenuation member does not extend across a degree of freedom of the joint formed between the first and second housings.

19. The humanoid robot of claim 14, wherein a gap is formed between an outer surface of the first housing and an outer surface of the second housing in a fully flexed position; and
wherein said gap is greater than 0.635 centimeters.

20. The humanoid robot of claim 14, wherein the attenuation member and the first housing collectively define an outer surface that lacks a recess with a depth that is greater than 5 mm at any location in the recess.
